(19) United States
(12) Patent Application Publication
(10) Pub. No.: US 2022/0260153 A1
(43) Pub. Date: Aug. 18, 2022

(54) GEARBOX, IN PARTICULAR A TWIN GEARBOX, AND BEARING BRACKET WITH AN ADVANTAGEOUS OIL LUBRICATION BY MEANS OF A MULTI-CHAMBER SYSTEM, AS WELL AS METHOD SUITABLE FOR LUBRICATING SUCH A GEARBOX

(71) Applicant: HOFER POWERTRAIN INNOVATION GMBH, Garching b. München (DE)

(72) Inventors: Mathias LUTZ, Tübingen (DE); Klaus KALMBACH, Mössingen (DE); Markus LEE, Nürtingen (DE); Fabian KELCH, Stuttgart (DE)

(21) Appl. No.: 17/625,310

(22) PCT Filed: Jul. 9, 2020
(86) PCT No.: PCT/EP2020/069463

§ 371 Date: Jan. 6, 2022

(30) Foreign Application Priority Data
Jul. 9, 2019 (DE) 20 2019 103 770.9
Jul. 9, 2019 (DE) 20 2019 103 771.7
Jul. 9, 2019 (DE) 20 2019 103 778.4
Jul. 9, 2019 (DE) 20 2019 103 779.2
Jul. 9, 2019 (DE) 20 2019 103 781.4

(51) Int. Cl. F16H 57/04

(52) U.S. Cl. CPC F16H 57/0494; F16H 57/0435; F16H 57/0457; F16H 57/0423; F16H 57/0452

(57) ABSTRACT

A twin transmission of a dual electric machine powertrain is presented. The twin transmission has a gear stage, a sump, a multi-chamber system adjacent to the gear stage, and a delay arrangement with a hydraulic flow restrictor. The multi-chamber system provides a flow path that continuously delivers a lubricant into the sump through the hydraulic flow restrictor.

The present invention relates to a transmission (gearbox), in particular a twin transmission (gearbox) of a duo electric machine powertrain, having a sump and a multi-chamber system via which individual gears of the transmission can be lubricated.

The present invention also relates to a spectacles-type bearing bracket having a hole structure for receiving in each case one end of two drive shafts, by which advantageous lubrication in the region of these shaft ends of the transmission is possible.

Furthermore, the present invention relates to a method for lubricating a transmission, in particular a twin transmission of a duo electric machine powertrain, in which running surfaces of gears and preferably transmission bearings of the transmission are lubricated by means of a passive lubricating film distribution.

In other words, the present invention relates to a transmission according to the preamble of claim 1.

The present invention also relates to a transmission according to the preamble of claim 5, and to a spectacles-type bearing bracket according to the preamble of claim 14.

In addition, the present invention relates to a lubrication method according to the preamble of claim 15.

### TECHNICAL FIELD

Electrically powered vehicles can be designed in such a way that at least two wheels, for example the two wheels of a rear axle, are driven by a dedicated electric motor. The electric motor often rotates at high speed compared to the desired wheel speed (for example at up to 15,000 rpm, in higher-speed designs at up to 18,000 rpm or even at up to 20,000 rpm). For this reason, the speed of the electric motor must be reduced (for example by a ratio i between 6 to 9, possibly even by a ratio i in a ratio range of 4 to 12). The first electric motor acts on an input gear of a first step-down gearing. The second electric motor acts on a different, second input gear of a second, different step-down gearing. The transformation to driven shafts, which at the same time may be the wheel half-axles of the motor vehicle, takes place via one or more stages. If the two transmissions are installed in one complete transmission case (overall transmission housing), the electric motors may be flanged onto the side of the transmission case, i.e. the first electric motor onto a first side and the second electric motor onto another side.

Powertrains designed in such a way are presented both in the drawings of JP 2016 205 444 A (publication date: 8 Dec. 2016; applicant: NTN TOYO BEARING CO LTD) and in the drawings of JP 2017 019 319 A (publication date: 26 Jan. 2017; applicant: NTN TOYO BEARING CO LTD).

Such transmissions can be referred to as dual transmissions or also as twin transmissions because ultimately two completely independent transmissions are joined to form a larger transmission unit. Owing to the two electric machines that are present, which are usually of identical type, the expression “duo electric machine” can also be used.

Any actuations, particularly with regard to speed and torque, of the connected wheels can be carried out with the aid of motor controls. Such a powertrain is commonly referred to as electric “torque-vectoring”. This enables a continuously variable control of the respective wheel torque on the driven wheels of the motor vehicle, particularly when cornering, as a result of which the driving stability of the motor vehicle can be improved and steering effort can be reduced. This category of transmission can also be referred to as an active differential. This type of transmission also increases the efficiency of a powertrain of a motor vehicle. In the case of motor vehicles that have just one driving traction motor at a time, transmissions of the superimposing type are required for this. Based on the mode of operation, therefore, the transmissions can also be referred to as multiple single-wheel transmissions.

### PRIOR ART

Dual transmissions are often ultimately designed as two completely separate single transmissions connected by a common partition wall, as can be seen, for example, from the drawings of JP 2016 205 444 A (applicant: NTN TOYO BEARING CO LTD; laid-open date: 8 Dec. 2016) and CN 201 800 514 U (applicant: Anhui Oulin Electrical and Mechanical Co. Ltd.; laid-open date: 20 Apr. 2011). Although the single transmissions are structurally joined together, they can nevertheless be regarded in many respects as separate, independent units.

A somewhat different case structure in comparison to the aforementioned disclosures is presented in FIGS. 1 and 4 of WO 2010/021 413 A2 (applicants: Aisin AW Co. Ltd., Toyoto Jidosha Kabushiki Kaisha; laid-open date: 25 Feb. 2010). On one side the case has a central partition structure, whereas toward the driven shafts the case encloses the two sub-transmissions, but rises again in the middle. Because the torques may be relatively large, with the magnitude thereof depending on the actual dimensions of the electric machines, a relatively large connecting structure should be expected for a case structure according to WO 2010/021 413 A2, which significantly contributes to the weight of the transmission.

WO 2018/121 420 A1 (applicant: BYD Co. Ltd.; publication date: 5 Jul. 2018) describes a dual transmission in which the two transmissions arranged next to each other can be coupled to each other via a clutch. The case of the transmission is said to be composed of three components, of which a middle component is described in greater detail in various exemplary embodiments. This middle component of the case serves as a central bearing for all the transmission shafts. FIG. 5 and FIG. 6 are said to show an exemplary embodiment without a clutch. The other exemplary embodiments deal with the case structure for the arrangement of the clutch. It is said to be possible to synchronize a first shaft of a first sub-transmission with a second shaft of a second sub-transmission.

US 2016/226 289 A1 (applicant: Acrimoto, Inc.; publication date: 11 Aug. 2016) describes a dual drive system for a vehicle, the two sub-transmissions of which are mechanically decoupled from each other. The case thereof comprises a central frame, to which covers are attached on both sides. The central frame is said to have a first set of bearings on a first side for the first motor shaft, for the first drive connection shaft and for intermediate shafts, and a corresponding second set on a second side. A fluid exchange between the two transmission regions is said to be permitted.

US 2014/353 052 A1 (applicant: Honda Motor Co. Ltd.; publication date: 4 Dec. 2014) relates to a vehicle which is said to be constructed in the manner of an inverted pendulum. The vehicle has a dual transmission, which has a centrally arranged case component in which shafts are mounted. This component is also referred to as the intermediate case, which is embedded between a left case half-body and a right case half-body held together by bolts.

Further interesting aspects, concerning in particular the arrangement of shafts and gears in the transmission, can be found in US 2018/015 815 A1 (applicant: NTN Corporation; publication date: 18 Jan. 2018) and in WO 2016/152 454 A1 (applicant: NTN Corporation; publication date: 29 Sep. 2016).

Usually, the transmissions have to be lubricated. Depending on the design of the electric machines, however, it may happen that the transmissions must be able to handle two directions of rotation (forward running/reverse running). Depending on the application, electric machines are designed in such a way that they can be operated as drive machines in motor mode or sometimes also in generator mode.

In such transmissions, therefore, special attention must be paid to the reliable lubrication of the transmission. Transmissions that do not require their own pump circuit are advantageous both from an energy point of view and from a financial perspective.

Immersion sump lubrication is common at various points in a powertrain. Immersion lubrication is said to keep energy losses caused by splashing to a minimum.

DE 10 2014 216 753 A1 (publication date: 19 Mar. 2015; applicant: BorgWarner, Inc.) and DE 10 2015 202 711 A1 (publication date: 27 Aug. 2015; applicant: BorgWarner, Inc.) describe a type of transfer case in which a lubricant collecting receptacle, also referred to as a fluid receptacle, is part of a reservoir system arranged at a distance from the sump of the transmission. DE 10 2014 216 753 A1 further states that the lubricant is collected with the aid of a collecting plate and therefore the fluid receptacle must have an air outlet so that air distributed in the oil can be separated from the oil in the collecting receptacle. DE 10 2015 202 711 A1 states that the oil system is designed for normal operation and for operation with a higher torque demand. Via a valve that is operated by way of an electronic control unit, a relatively large amount of lubricant can be released through the valve. All the transfer cases shown are based on oil being conveyed by a pump, the oil being intended to hit against a collecting element, such as a collecting plate. As can be seen from DE 10 2015 202 711 A1, the distribution of the oil must also be adjusted by an electronic control system. In other words, although DE 10 2014 216 753 A1 addresses parasitic energy consumption, both publications still consider it necessary to install numerous parasitic consumers in order to maintain the oil flows and oil distribution in a transmission.

A much more primitive variant of oil storage in a three-axle reduction transmission can be seen in the figures of WO 2017/063 595 A1 (applicant: BEIJING ELECTRIC VEHICLE CO., LTD.; publication date: 20 Apr. 2017), also published as CN 205 101 518 U and as CN 105 179 650 A, wherein the shafts lie next to each other in one plane. A horizontal installation orientation of the transmission, a transmission orientation when traveling downhill and a changed oil level when traveling uphill are shown schematically. Perpendicularly arranged bars in a sump are shown, as a result of which oil can be held back behind the bars. In addition, the bars may have holes for a throughflow into the sump. During horizontal operation of the vehicle, the liquid level is said to be always above this so-called separation arrangement, so that some of the lubricating oil always flows back into the static storage area. The entire system is referred to as a dynamic oil reservoir with a cyclic oil inlet and a cyclic oil outlet.

Documents JP 2009 030 743 A (applicant: Nissan Motor Co. Ltd.; publication date: 12 Feb. 2009), JP 2009 180 281 A (applicant: Aisin Al Co. Ltd.; publication date: 13 Aug. 2009), JP 60 215 159 A (applicants: Fuji Tekkosho K.K., Nissan Motor Co. Ltd.; publication date: 28 Oct. 1985), JP 2007 032 797 A (applicant: Toyota Motor Corp.; publication date: 8 Feb. 2007) and DE 38 19 519 A1 (applicant: Siemens AG; laid-open date: 21 Dec. 1989) present transmissions, such as rear-axle transmissions or differential transmissions, which may have an upper (in the context of an installation direction) oil pan in which oil can be collected, which oil can then be discharged again according to various criteria, such as temperature or such as point distribution.

DE 10 2009 057 458 A1 (applicant: American Axle & Mfg., Inc.; laid-open date: 1 Jul. 2010), also published as US 2010/144 480 A1, shows in one of its rear exemplary embodiments an axle transmission that has a plurality of collecting containers along a shaft, between which partition walls define the height of the respective oil chamber. Lubricating oil that has been conveyed via a ring gear to the edge of the collecting container can be collected in the collecting containers, and only once the collecting container in question is completely full is the excess oil routed onward to the next collecting container. Such a device can fill lubricating oil, which initially comes from a sump, into the collecting containers at the start of an operating phase. The lubricant, which is conveyed counter to the force of gravity, then returns to the sump via channels, the recirculation path also being routed via parts of the transmission that are to be lubricated.

The description of JP 2017-129 205 A (applicant: NTN Toyo Bearing Co. Ltd.; publication date: 27 Jul. 2017) relates to a drive unit comprising an electric motor and a speed reducer, i.e. a transmission having a ratio>1. Each transmission has three shafts, with an output gear and a central gear splashing into a sump. An oil supply plate is mentioned, which is said to be insertable into the transmission case; two different embodiments of said plate are shown on the basis of FIGS. 8 and 11. Said plate is said to enable lubricating oil to drip onto a desired location, namely onto the region where the smaller gear of the central gear, which is designed as a double gear, meshes with the output gear, because the smaller gear does not rotate in the oil bath. As shown in FIG. 7 of JP 2017-129 205 A, the plate can be formed with a triangular wall part, which has a drip opening at its tip. No onward routing into an adjacent region for oil recirculation can be seen.

In DE 10 2006 043 723 A1 (applicant: Daimler AG; laid-open date: 27 Mar. 2008) an all-wheel drive unit is described, in which the oil level of a main transmission is said to be kept as constant as possible so that the transmission oil pump does not intake any air. As indicated by droplets shown in FIG. 3 of DE 10 2006 043 723 A1, oil is conveyed via an outlet opening from an output bevel gear to a storage chamber. The storage chamber has a bore provided at the bottom thereof, via which the oil flows into a power take-off chamber. In the storage chamber, it is possible to distinguish between a left and a right storage chamber area, but there are no partition walls. The gears of a transfer case are passively lubricated gears, but the transmission as a whole is described as a main transmission with a pressurized supply of transmission oil.

Patent application JP 2017-129 178 A (applicant: NTN Toyo Bearing Co. Ltd.; publication date: 27 Jul. 2017) also relates to a transmission for two electric motors. A bottom region of the transmission case is said to serve as a lubricating oil tank. Splash gears of the transmission are said to convey the oil out of the lubricating oil tank. Said case also contains a lubricating oil store, which is located in the case above the lubricating oil tank, on the outflow side of which a valve is provided that can be opened and closed in order to connect the reservoir of the lubricating oil store. Oil from this additional reservoir is thus said to be actively connected only in phases of particularly high speeds. After start-up and during operation, the valve is otherwise kept in the closed state. This storage region is said to be arranged in an axial direction, i.e. laterally, in relation to the input gear and the bottom region thereof is said to lie below a center of the middle shafts. It is intended for oil that is splashed onto the case by the output gear to flow along an upper surface of the case to the input gear shafts. The oil is then intended to collect in the lubricating oil store in that region.

Further interesting transmission configurations are described in the following documents:

DD 143 174 A (inventors: W. Beyer et al.; publication date: 6 Aug. 1980),

WO 2017/138 312 A1 (applicant: NTN Toyo Bearing Co. Ltd.; publication date: 17 Aug. 2017),

JP 2005-083 491 A (applicant: Toyota Motor Corp.; publication date: 31 Mar. 2005),

JP 2014-015 976 A (applicant: Honda Motor Co. Ltd, Yanagawa Seiki Co. Ltd.; publication date: 30 Jan. 2014),

JP 2014-015 977 A (applicant: Honda Motor Co. Ltd, Yanagawa Seiki Co. Ltd; publication date: 30 Jan. 2014),

JP 2007-032 797 A (applicant: Toyota Motor Corp.; publication date: 8 Feb. 2007),

JP S60-215 159 A (applicants: Fuji Tekkosho: KK, Nissan Co. Ltd.; publication date: 28 Oct. 1985), and

JP 2017-019 319 A (applicant: NTN Toyo Bearing Co. Ltd.; publication date: 26 Jan. 2017).

The documents mentioned above are deemed to be fully incorporated in the description of the present invention by way of reference. This is intended to avoid repeatedly explaining generally known relationships between transmissions, the gears thereof and the associated lubrication by using the force of gravity; instead, this should be regarded as likewise defined for the present invention by way of reference to said documents.

### Problem

There is a need for suitable lubrication concepts by which twin transmissions in particular can be used with sufficient lubrication as early as possible, i.e. as close to the start of operation as possible or right from the start of operation. On the other hand, excessive amounts of lubricating oil are undesirable, not least for energy reasons. Once there is sufficient initial lubrication, i.e. the lubricating film has been built up, the question arises as to what amount of lubricant is actually required by the transmission.

Much consideration and thought must be given as to how a suitable transmission, which is preferably of compact construction and designed for long operating times under changing loads, can be designed, particularly with regard to its lubrication concept using preferably transmission oil, in particular as part of an electrically driven powertrain.

### DESCRIPTION OF THE INVENTION

The problem addressed by the invention is solved by a transmission according to claim 1.

The problem addressed by the invention is also solved by a transmission according to claim 5 and by a spectacles-type bearing bracket according to claim 14.

In addition, the problem addressed by the invention is solved by a lubrication method according to claim 15.

Advantageous further developments can be found in the dependent claims.

A transmission typically includes gears, in particular spur gears, and bearings, in particular rolling bearings, needle bearings or ball bearings, which are to be lubricated by means of a lubricating film, such as an oil film for example. The gears are located in the interior of one of the sub-cases of the transmission. The lubrication, preferably using oil, preferably takes place in a passive manner, i.e. the lubricating film, namely the oil film in the case of oil, is distributed by being conveyed in rotation and moved onward by means of gears (splashing). It can also be said that the gears entrain the oil film. After being at a standstill (for a relatively long period of time), but as soon as the gears rotate again, the oil film is gradually distributed over all the gears, in particular by building up the oil film again. The gears are designed to lubricate themselves. The oil lubrication takes place in the interior of the transmission case (transmission housing).

Splashing enables a lubrication of the transmission when the transmission is running forward and also when the transmission is running in reverse, i.e. when the direction of rotation is reversed. Lubrication is particularly advantageous during a load reversal, when the tooth flanks to be lubricated on the gears change. Four operating modes can be mentioned: forward traction, reverse propulsion, reverse traction, and forward propulsion, for which lubrication is ensured both in the motor mode and in the generator mode of the electric machines.

However, the transmission is not completely filled with the lubricant, which in particular is a liquid lubricant, but rather the total available volume (in each sub-transmission) is greater than the volume taken up by the lubricant in the interior of the transmission. Therefore, at least one of the gears is at least partially in an air environment, but as a result of its lubrication and its rotations may be separated from the air by an oil lubrication film.

A certain amount of lubricant is located in the sump, the fill level of which should be highest after relatively long standstill phases of the transmission.

Once the intended fill level of the transmission is reached, i.e. the amount of lubricant in the transmission is at its intended level (target fill level), at least one first gear dips with at least one gear segment into this sump to such an extent that the lubricant can adhere to the dipping part of the gear. Of particular interest is the state immediately after a relatively long standstill phase, specifically when the transmission starts to run again. When at a standstill, therefore, part of a first gear, such as a first spur gear, dips into the sump.

In addition to the first gear, there is a second gear as part of the twin transmission. The first gear and the second gear are intended to mesh with each other; together they form a gear stage. In particular, the transmission comprises more than the two gears mentioned in the introduction.

In addition to the gears of the transmission, the transmission has a multi-chamber system. The multi-chamber system is located in the vicinity of individual gears of the transmission. In particular, it is advantageous if the multi-chamber system is located next to a gear stage, preferably in the immediate vicinity of the gear stage, in order to store lubricant or transmission oil in the vicinity of the gear stage. The reservoir formed by the multi-chamber system is located physically close to at least one gear stage.

Ideally, there is at least one gear in the transmission that can be referred to as the highest gear (for example in relation to a bottom position). There is a (preferred) installation position for the transmission. One of the possible positions of the transmission is an ideally suited orientation of the transmission, in which the transmission can be attached to a vehicle by attachment means. When the transmission is in this particular position, the transmission is said to be in the installation position. Due to the design of the transmission (for example due to the locations of the attachment points), one installation position is assigned thereto. If the transmission is viewed in an (imaginary) positioning in its installation position (for example by being viewed in section), there are gears that are positioned closer to the ground, and there is at least one gear that can be referred to as the closest to the side of the transmission remote from the ground. The at least one gear remote from the ground serves not only to transmit power and torque, but also for conveying the lubricant onward, in particular in the form of a lubricating film that wets the gear.

The gear referred to as the second gear is part of a gear transmission chain (transmission path) having multiple gear stages. As part of a powertrain, the torque(s) of which is/are provided by electric motors, the transmission is designed to reduce the speed on the output side of the transmission, as will be explained below. Via the individual gear stages, the speed is reduced from stage to stage. During operation of the transmission comprising this chain of individual gear stages composed of multiple gears, the second gear rotates at a medium speed. At least one gear, but possibly also multiple gears, is an upstream gear in the flow of torque through the transmission. In the motor drive mode of the transmission (traction mode), the at least one upstream gear rotates faster than the subsequent, in particular second gear. Further gears may be arranged after the second gear in the flow of torque in order to achieve even lower rotational speeds or lower speeds.

The second gear can thus be described from different viewing angles or from different perspectives.

One way of designating the second gear is based on the installation position of the gear when the transmission is in the installation position. The second gear is the gear in the transmission that is located furthest away from the ground or from a road. However, the gears can also be named or defined on the basis of the (relative) speed compared to each other in a similar way. The second gear is the gear that is intended to rotate not at the highest speed and also not at the lowest speed, but rather for rotation, which takes place in a medium speed range (when considering all the speeds of all the gears and comparing these with each other).

In addition, the second gear serves to remove some of the lubricating film that is formed on the gear, for example by knocking it off, separating it or stripping it. Ideally, even after some of the lubricating film has been removed, lubricating film still adheres to the gear, in particular for as long as the transmission is in operation (rotating). Any excess of lubricant or lubricating oil can be discharged via the second gear to the multi-chamber system. The centrifugal force that is available when the transmission is working properly is advantageously used for this. Such a separation by means of centrifugal force can be brought about or facilitated by means of a rake, a separator plate or a spatula-like lubricating film or oil separator. In other words, in addition to its task of distributing the lubricant, the second gear also performs the function of a centrifugal lubricating film separator gear. By using the centrifugal force, the gear is used to separate some of the lubricant and to introduce it into a processing and recirculating device provided by the multi-chamber system.

The multi-chamber system is designed to route the lubricant back into the sump. The intention here is not to interrupt the returning flow of the lubricant, during operation of the transmission, once it has started to flow. However, one of the aims of the multi-chamber system is to remove a proportion of lubricant or a quantum of lubricant from the direct supply of lubricant to the gears. This can be done by controlling the recirculation. One approach is to influence the supply of lubricant by using at least one delay means. The lubricant, i.e. the oil when oil is used as the lubricant for the transmission, more precisely the oil introduced into the multi-chamber system by the centrifugal lubricating film separator gear, runs continuously back into the sump in order to be available again from there for gear lubrication. The multi-chamber system thus provides a flow path for the lubricant. The lubricant can return to the sump along the flow path. Ideally, however, although this is referred to as a continuous recirculation, at least one delay means is provided in the flow path so that (in relation to the total amount of lubricant) a delayed recirculation (i.e. in relation to the total flow quantity) can occur. The multi-chamber system makes it possible to initially hold back or store a quantum of lubricant.

The acceleration force exerted on the lubricant by acceleration due to gravity is used to achieve a return flow through the multi-chamber system toward the sump.

The transmission, which is advantageously designed as a twin transmission for individual drive in two powertrains, i.e. for a separate, dual drive via the same transmission, comprises multiple assemblies and components, including a multi-chamber system which advantageously comprises at least three chambers. The three chambers of the multi-chamber system include different chambers (by way of example, the distinction between the chambers can be made on the basis of their function). It can also be said that the chambers perform different tasks in the transmission. To achieve its variable tasks, the chamber system has several chambers. Based on the different tasks and functions of the various chambers of the multi-chamber system, the chambers may be of different size. In one embodiment, which is as space-saving as possible, the chambers are intended to be filled with lubricant as fully as possible after an initial phase of operation. It can also be said that the multi-chamber system has at least two chambers which have different volumes to each other. The chambers can be characterized on the basis of their respective function, or also on the basis of their dimensions and their lubricant-holding volumes.

Once the transmission or the powertrain has been started, the gears and thus the components of the gear stages begin to rotate. From an energy point of view, it is advantageous if the distribution of the lubricating film over the gears takes place not by using a circulating pump, but rather as a result of the lubricant being entrained from one gear to the next gear. This should take place until all the gears are covered with lubricant, at least with regard to their teeth in revolutions. For the initial phase, it is possible to postpone the wetting of the end faces of the gears with a lubricant, in particular with an oil.

By rotating different gears of the transmission, the lubricant is distributed along the running surfaces of the transmission and its gears. This can be referred to as a passive lubricating film distribution because no active components, in particular components that provide pumping power, are installed in the transmission, but rather the gears themselves ensure the teeth-covering lubricating film and the distribution thereof.

The gears are designed to rotate, with each gear being designed for its own speed range. One of the gears, in particular the gear located in second place in the output flow or torque flow, can be used as a lubricant-dispensing gear. For the dispensing, use can advantageously be made of a centrifugal force that acts on the lubricant as a result of the rotation of the gear.

The situation regarding the reserve of lubricant can also be explained as follows:

The multi-chamber system stores a certain quantity of lubricant during operation of the transmission and returns this quantity to the (re-)circulation only after some time. The rotation, in particular of the second gear, can advantageously be used to separate the lubricant by using a centrifugal force. The separated lubricant (at least partially) enters the multi-chamber system, more precisely a first receiving chamber which is, for example, a reservoir chamber.

A recirculation path leads from chamber to chamber. On the other hand, after an initial operation start phase, a certain amount of lubricant is to be applied from the lubricant circuit. It can also be said that the lubricant is returned to the lubricant circuit in a delayed manner. These delays can be brought about by one or more delay means in the recirculation path. Once the lubricant returns to the sump, it is available to be distributed over the gears again. A first gear is permanently operated from the sump of the transmission and distributes the lubricant from gear to gear, more precisely from running surface to running surface of the individual gears, in order to lubricate the surface of the gears, in particular the teeth of the gears.

According to the invention, a method for lubricating a transmission is described, the transmission preferably being a twin transmission, in particular a spur gear transmission, of a duo electric machine powertrain. The lubricating film is distributed in a passive manner. As they rotate, rotating gears of the transmission entrain lubricant and distribute it over all the running surfaces of the transmission. Centrifugal force brought about by the rotation splashes the lubricant. Provided in the transmission is a multi-chamber system, in which the lubricant, in particular lubricating oil, is stored. The lubricant splashed by the gears is received by one chamber of a multi-chamber system. It is then supplied to a further chamber, where it is stored. Only via a delay means is the lubricant recirculated back into a sump of the transmission, in a delayed manner, in order to cover a first gear of the transmission again for surface lubrication.

A continuous lubricant circuit may also be formed, in particular in addition to the previously described circulation path, via a spectacles-type bearing bracket in a transmission case. The spectacles-type bearing bracket preferably has a plurality of chambers which delay a return flow of the lubricant back into the sump. A spectacles-type bearing bracket according to the invention has a single hole structure. The hole structure receives in each case one end of two driven shafts. The hole structure is a single, preferably centrally arranged through-opening in the spectacles-type bearing bracket. The spectacles-type bearing bracket has oil supply surfaces. These are sheet-type, plate-type or blade-type elements which route oil that hits them in the direction of the hole structure, so that the oil enters the interior of the hole structure in order to lubricate the bearing located therein. The oil supply surfaces may extend along a plate body of the spectacles-type bearing bracket, for example from an edge of the spectacles-type bearing bracket toward a center of the spectacles-type bearing bracket. Preferably, the oil supply surfaces are formed as part of a supporting structure or web structure. The spectacles-type bearing bracket can also be referred to as a single-hole support structure. In particular, the oil supply surfaces extend at an angle. In other words, the oil supply surfaces may have a slope that leads to the driven shaft receiving opening. The oil collects at the end region thereof located at the driven shaft receiving opening, and therefore this can also be referred to as a collection chamber or oil collection region. This is followed by a lubrication reservoir, which merges into a reservoir chamber. In other words, the collection chamber is adjoined by a preferably funnel-shaped reservoir chamber, in particular in a barrier-free manner. Where the term “connected” is used here, this also expresses the possibility that the chambers are provided in a one-piece spectacles-type bearing bracket, for example as a multi-chamber system formed in particular by metal casting of the spectacles-type bearing bracket. The reservoir chamber opens via a lubrication opening or via a lubrication nozzle into a bearing lubrication chamber of the hole structure. The bearing lubrication chamber is bounded laterally by two rolling-element bearings or rolling-body bearings, such as two barrel bearings. A gap between these rolling-element bearings defines a size of the bearing lubrication chamber in one spatial direction. The bearing lubrication chamber preferably has a cylindrical volume. Lubricating oil that collects in the bearing lubrication chamber can flow off laterally toward the rolling-element bearings. From the rolling-element bearings, the lubricating oil, driven by the force of gravity, passes back into the sump in a delayed manner. Preferably, a flow-off direction toward a bearing is defined by an angle position of the lubrication nozzle, which deviates from a case longitudinal direction. The collection chamber and the reservoir chamber are preferably provided as a pair on the spectacles-type bearing bracket, for example on both sides of the plate body of the spectacles-type bearing bracket. This ensures that sufficient oil constantly reaches the two rolling-element bearings, i.e. continuously without any break in the flow. Furthermore, an oil level in the sump is kept low during operation of the transmission.

As is apparent from the description of the process of distributing the surface lubricating film, this is a continuous lubrication process. The initially dry gears are supplied with lubricant to their surfaces within the first few revolutions, ideally already by the first complete revolution. Any excess, i.e. a superfluous proportion of the lubricant, is routed back to the sump via the multi-chamber system. Owing to a delayed or reduced or slowed return, lubricant volumes accumulate in the multi-chamber system. The lubricant is discharged into the sump in smaller volumes in a delayed manner. Some of the lubricant remains in the chambers of the multi-chamber system. Only when the gears are dry due to the effects of gravity should the lubricant in the multi-chamber system be returned to the sump.

The delay in the return flow of the lubricant into the sump, which is brought about by the one or more delay means, should take as long as the gears take to dry (in particular due to the return flow).

Advantageous embodiments and further developments will be presented below which, considered per se, both individually and in combination, may likewise disclose inventive aspects.

The transmissions, which in particular as so-called reduction transmissions, i.e. as transmissions with a step-down ratio, are parts of electric powertrains, should as far as possible be designed in such a way that, particularly with regard to the limited electrical storage capacity in motor vehicle construction, as far as possible all of the electrical energy is available for the drive, i.e. as little electrical energy as possible should be “consumed” for auxiliary units, other tasks or as a result of power losses. The input shafts of the transmission according to the invention, in particular a dual transmission, and the output shafts of the transmission are arranged in a middle region in relation to an extension transverse to a direction of travel, i.e. in particular a relatively short distance from one case wall to an opposite case wall of the transmission case, in particular at the same height. The input shafts and the output shafts define a reference plane within the transmission case. The position of a middle axle of one of the gear centers, which is in angular alignment with the reference plane, is provided as a position at a distance from the transmission case bottom. This elevation of the position of the middle axle in relation to the reference plane gives rise to an axle arrangement of all the gear centers in the manner of a triangle. In this (imaginary) triangle, a first side, preferably a long side, such as a hypotenuse, is preferably brought into coincidence with the reference plane. In this (imaginary) triangle, a second side and a third side preferably form two short sides, which each intersect the first side, in particular at a respective end of the first side, in each case a straight line, such as two legs or such as an opposite leg and an adjacent leg. Straight lines that follow the short sides opposite the first side intersect the reference plane or the first side at an inclination having a value that can be taken from the angle range between approximately 5° and 70°. In other words, the second side and the third side can each form an (imaginary) corner enclosing an angle with the first side. It is advantageous if an angle is selected from an angle range between 10° and 50°. Various mathematical simulations and calculations have led to the situation where angles in an angle range between 15° and 48° appear to be particularly advantageous.

The transmission case is preferably installed in the motor vehicle with its case longitudinal direction or case longitudinal axis along a vehicle longitudinal axis, in particular parallel thereto, preferably even arranged on the central longitudinal axis of the vehicle. The input shafts and the output shafts extend transversely to the case longitudinal direction, i.e. preferably form an angle of approximately 90° with the case longitudinal direction.

In order to further specify the transmission category presented in the introduction, it can also be said that the transmission, the transmission case of which can be based on two half-shells, in the interior of each of which a preferably stand-alone transmission is realized, is constructed as a paired transmission, i.e. in an almost twin-like manner; another term for this is a twin transmission. The twin transmission is part of a motor vehicle powertrain. The motor vehicle powertrain includes two electric machines. Using the transmission, each electric machine is designed to drive a road wheel assigned to the respective electric machine. From one electric machine, the flow of torque to one of the road wheels is provided using half of the transmission.

The transmission case offers multiple positions for gear centers. Two positions for gear centers are occupied by the drive shaft(s) and by the driven shaft(s). A first position is occupied by two input shafts of the dual transmission. A second position for gear centers is occupied by the two output shafts. Located between the first position and the second position is a middle or third position, which is not in line with the two other positions. This position of a middle axle of one of the gear centers, which is in alignment with the reference plane, is provided as a position at a distance from the transmission case bottom. This can also be referred to as a roof-ridge-like arrangement of the middle axle relative to a loft-like plane. Overall, this elevation of the position of the middle axle in relation to the reference plane gives rise to an axle arrangement of all the gear centers in the manner of a triangle.

Owing to the arrangement of the middle axle above the reference plane, it is possible for the two other shafts and thus the reference plane to be located low in the vehicle, i.e. closer to the ground. The center of gravity of the motor vehicle can thus be placed in a low position, for example less than 50 cm or even less than 30 cm from the ground. In other words, the electric machines (operated as electric motors in the mode of operation considered here) that act on the input shafts and drive the input shafts, with their individual weights (due to their copper components), can be mounted in the motor vehicle at a height (as viewed from a road) that corresponds to the position or height (as viewed from the road) of the output shafts. This results in particular in a more stable cornering behavior for a compact case design in the longitudinal direction of the transmission case. If cornering is realized or aided by “torque-vectoring”, this increases the permissible cornering speeds.

As already mentioned above, the transmission is advantageously a passively lubricated transmission, in particular in the form of a twin transmission. The transmission, which is driven by an electromotive drive source, consumes as little energy as possible for auxiliary supplies, such as, for example, for conveying the lubricant through a lubricant pump. Instead, the transmission is lubricated passively, more precisely by the gears themselves and by the level of lubricant, in particular oil, present in the transmission during regular operation. In other words, the transmission can be referred to as a pump-free transmission when discussing the lubricant circuit, more precisely the lubricating oil circuit. With regard to the lubricant circuit, such as the oil circuit for example, the transmission is a pump-free transmission.

A return flow of the lubricant advantageously takes place by using or under the effect of gravity. Counter to this effect of gravity, the lubricant is distributed over the gear surfaces of the gears by virtue of the fact that the gears rotate and take over the lubricant from the previous gear stage or from the previous gear.

For reasons of clarity, it should be noted that, in the traction mode of the transmission, the lubricant path for distributing the lubricant over the gears may differ from the torque path through the transmission. In one positive embodiment of the transmission, a gear located in last place in the torque path can be used as a lubricant input gear. Considered somewhat more abstractly, gears arranged in a middle region in the torque path or even a last gear in the torque path can be used as gears lubricated first. As a result, the lubricant can be distributed by rotation and by mutual tooth meshing between gear and gear, starting from these middle gears or from the gear arranged on the output side and moving in the direction of the gears arranged more toward the edges of the torque path.

The lubricant is distributed over the running surfaces of two gears of the transmission by utilizing the gear rotations.

As delay means, consideration is given to hydraulic components which cause the hydraulic medium, the lubricant or the transmission oil, to move more slowly or in a reduced volume. Such (hydraulic) delay means are, for example, nozzles, shutters, chokes and flow valves. A lubricant flow-off can be delayed, for example, by constrictions in cross-section. The lubricant is routed back to the recirculation in a delayed manner. Another possibility for delaying is provided by particular delay paths. For example, a passively operated delay means can be realized via flow lengths and backpressure systems. As already mentioned in the introduction, delay means which are realized without active functional groups, in particular electrically operated functional groups, are particularly advantageous for energy-saving reasons.

The flow path may be designed for a continuous return flow of the lubricant after a first start-up phase. A flow path is a route in the transmission case along which the transmission oil passes, in a manner driven by the force of gravity, preferably without being assisted by a powered conveying device, from a higher point to a predefined lower point. Preferably, the multi-chamber system remains in the open state after the end of operation of the transmission. This can also be referred to as a passive multi-chamber system if no active, i.e. switchable, element is provided between the chambers. The transmission preferably has at least one open return flow or return flow path and/or at least one open forward flow path. After a few rotations of transmission gears, a constant return flow of oil spun out from the sump can be formed, with reservoir-forming devices being provided on the path or paths specified for the return flow. The reservoir-forming devices delay the return flow in comparison to running off on a direct route from a collection region or from a drip-on region into the sump.

For the individual torque paths, separate gearing/transmission assemblies may be provided in the transmission, said transmission being composed of sub-transmissions which in particular are designed to transmit torque independently of the respective other sub-transmission. In other words, the transmission can also be regarded as a block of multiple single transmissions, the (so-called) sub-transmissions. Ideally, each sub-transmission is (substantially) identical to another sub-transmission of the transmission. Each sub-transmission comprises multiple stages. To reduce the speed at which the output shaft of the respective sub-transmission rotates, at least two stages may be provided, but also three or more stages may be provided in order to reduce the speed further. Spur gears are advantageous, from which the individual stages are constructed. To enhance integration and/or to aid the compactness of the transmission and of its sub-transmissions, stepped gears may be provided. In this design, two stepped gears, or even more, may be provided in the transmission. One possible embodiment of the transmission consists in having at least one stepped gear installed in each sub-transmission.

A stage is regarded as two gears which mesh with each other or which engage with each other in the transmission as a complete group to form the stage. If the sub-transmission is considered from such a perspective, a stepped gear does not form a stage, even though two gears of different diameter are coupled.

If aspects such as weight, manufacturing effort and installation space are taken into consideration when developing and designing the multi-chamber system, a favorable number of individual chambers, which together form the multi-chamber system, is the number 3. Three individual chambers are combined to form the multi-chamber system. Of course, it is also possible to construct the multi-chamber system from more than three chambers. However, each chamber requires its partition walls, so that a multi-chamber system larger than a three-chamber system requires a larger number of chamber partition walls. The partition walls may be provided in an integrated manner in a mold for producing case halves.

If the various delays and the delivery quantities during the different operating phases and operating states as well as the expected speeds of the transmission and of its gears are taken into consideration, it is advantageous to tailor the volumes and sizes of the chambers of the multi-chamber system to the average flow and/or reservoir quantity that is to be expected. The chambers are therefore not all the same size as each other; a last chamber, in particular leading directly into the sump, may for example be larger than a chamber upstream of this last chamber.

As already mentioned above, the transmission has a preferred direction, which corresponds to the installation orientation or an installation position. The transmission is designed for a very specific installation direction or position. When the transmission is in the installation position, the chambers of the multi-chamber system are located at different heights or levels. A single chamber of the multi-chamber system is advantageously the highest chamber. The chamber from which the run-off distance under the effect of gravity is longest (compared to other lubricant run-off distances), i.e. the lubricant run-off distance under the effect of gravity that may also lead via other chambers, can be referred to as the highest or uppermost chamber. The highest chamber can thus be defined on the basis of the run-off distances under the effect of gravity. A run-off distance under the effect of gravity exists in particular when oil, driven by the force of gravity, can take up a lower potential energy, for example by running off, driven by the force of gravity, from a point of impact on a surface or from a collecting reservoir, preferably until it is received again by a reservoir. The (re-)circulating lubricant, such as the lubricating oil for example, follows gravity. From the gravity point of view, there is a highest or uppermost chamber, namely the one that has the longest run-off distance, measured from the run-off side of a chamber. In other words, the uppermost chamber is furthest from the ground when the transmission is installed. This highest chamber may be designed as a drip and collection chamber. The highest chamber may be intended to receive the lubricant that is to be separated from the, in particular second, gear. Because centrifugal effects are also used when separating the lubricant, it may be advantageous to locate the drip and collection chamber as a collecting basin and thus in a cuff-like manner around at least one side of the gear provided for the separation. To concentrate the lubricant in the highest chamber, to collect the lubricant more quickly and also to clean the lubricant, the drip and collection chamber may additionally be equipped with a separating magnet. The separating magnet may be arranged, for example, at the bottom of the drip and collection chamber. The lubricant initially collects at the bottom of the drip and collection chamber. A first reservoir of lubricant can form in the collection chamber. Metal chips, contaminants and magnetically conductive parts can be taken out of the recirculating fluid that helps to cool the transmission, i.e. the lubricant, by means of the separating magnet.

One of the chambers of the multi-chamber system that follows (from the perspective of the flow path) the highest chamber, also referred to as the uppermost chamber, can be referred to as a reservoir chamber, in particular as a first or second reservoir chamber. From the reservoir chamber, the lubricant flows off, in particular exclusively, more slowly than it can flow off from the drip and collection chamber, inter alia due to a constriction in the flow path. Within a few revolutions or rotations of the gears of the transmission, lubricant accumulates in the reservoir chamber. In an initial phase of operation of the transmission, this lubricant located in the reservoir chamber takes longer to flow off than it does to accumulate, in particular due to separation from the second gear. The delayed discharge, in particular return flow, can also be brought about by using the force of gravity. Here, too, no further energy is used for control purposes.

The delay means, via which the delay with which the lubricant is routed back out of the first or possibly second reservoir chamber can be set, may be located on a discharge side of the reservoir chamber and may represent a sole possibility for discharging from the reservoir chamber. The delay means is advantageously arranged on the discharge side of the reservoir chamber. This ensures that the lubricant can enter the reservoir chamber from the drip and collection chamber in a non-delayed manner. Only the departure from the reservoir chamber is delayed. The entire chamber formed of the reservoir chamber and the drip and collection chamber as storage volumes is therefore provided as a collection and receiving space.

The sub-transmissions themselves are independent of each other. This means that the transmissions or the sub-transmissions of the (complete) transmission can each independently carry out a speed/torque conversion. In physical terms, it is advantageous to arrange the two sub-transmissions next to each other, in particular parallel to each other. Common axles and common shafts can thus be used. For example, the gears can be borne on common sleeves. In addition, such an arrangement makes it possible for a single multi-chamber system to be sufficient for the two sub-transmissions. Each of the sub-transmissions is a multi-stage transmission, i.e. each sub-transmission has a two-stage or three-stage transmission path. The transmission can also be referred to as a two-stage or three-stage spur gear transmission. The transmission paths are intended to convert higher speeds on the input side into comparatively lower speeds on the output side, i.e. to reduce the speeds. Each of the transmission paths is part of a separate powertrain. As already mentioned above, each powertrain includes a separate electric machine. Two electric machines are therefore provided in the case of a twin transmission.

Preferably, the transmission is a transmission having two three-stage transmission paths arranged in parallel, which in particular have a step-down ratio. Each transmission path is designed for a separate powertrain and has two connections, to which in each case one of the two duo electric machines can be connected for drive purposes.

Preferably, at least one gear of the transmission or of the sub-transmission is a stepped gear. Two stepped gears may be arranged in the transmission case. Each of the sub-transmissions has an internal volume. Two spatially connected, but rotationally isolated, sub-transmissions can be arranged in a single transmission case. The transmission case preferably encloses a contiguous internal volume. The sump occupies a variable part of the internal volume, it being possible for this part to decrease proportionally in relation to an increasing drive speed of the transmission. A simultaneous, sufficient lubrication of the sub-transmissions is ensured.

Immediately upstream of the sump of the transmission, the multi-chamber system may have a further chamber, in particular a lowermost chamber with regard to the installation position. This lowermost chamber is a pre-chamber to the sump. The pre-chamber to the sump can merge into the sump, for example with a further delay element interposed therebetween. By providing a pre-chamber in front of the sump, it is possible to operate with different fill levels between the pre-chamber and the sump during an operating phase of the transmission.

In one advantageous design, the multi-chamber system may be formed in such a way that it has several chambers in its interior, which are part of the run-off path intended for recirculating the oil. At the same time, the multi-chamber system may be formed in such a way that it also provides at least one depression or chamber outside its multi-chamber system, in order for example to keep in a (second or separate) sump a gear that lies or rotates in this depression, in particular a highly loaded gear. When increased lubrication or a supply of more lubricant to a gear or a gear stage of the transmission is necessary, a lubricant-collecting depression or chamber arranged in particular in the exterior of the multi-chamber system can ensure this increased supply of lubricant. The level of the lubricant in the sump and the level of lubricant in the further depression, which can also be referred to as the gear lubrication pan, may consequently differ from each other. The gear running in the gear lubrication pan thus performs the task of a further splash gear.

In other words, a transmission according to the invention may also be equipped with multiple sources of lubrication by providing, in addition to a sump, at least one further storage region for distributing a lubricating film.

The combinations and embodiments presented above can also be considered in numerous further connections and combinations.

From another perspective, it can also be said that the transmission has a lubricant supply path which extends in a manner differing from the torque flow path, said lubricant supply path being arranged in particular in a central region. A gear arranged downstream in the torque flow path, i.e. a second, third or fourth gear in the flow of torque, is a gear provided first for the lubricant and therefore is a centrally distributing gear. A first gear provided for introducing the flow of torque into the transmission, i.e. via which the flow of torque is introduced into the transmission, can draw the increased amount of lubricant that is requires from a gear lubrication pan. This gear lubrication pan may need to be filled the first time, i.e. in an initial phase. The lubricant is then available as an additional source.

In order to lubricate all the running surfaces of all the gears of the transmission as quickly and as comprehensively as possible, a gear supply for passively lubricating the gears is formed in a middle region. Starting from the middle, the lubricant is drawn over the other gears. Additional gear lubrication pans may be provided at the gears that require an increased supply of lubricant. Besides the actual sump of the transmission, therefore, there are one, two or more than two so-called auxiliary sumps. If such an auxiliary sump is designed without any run-off, then after an initial filling phase the gear that has an increased lubricant requirement is also a splash gear.

Material is saved in particular if walls of the chambers are formed by the transmission case, walls that provide at least partial separation between the chambers. A partition wall between two chambers may be formed by at least one partition plate, which is inserted into the case. Advantageously, partition walls between the chambers are integrally molded onto the transmission case, for example by casting. On account of low mechanical stress, partition walls that serve to guide the oil may be formed in the manner of sheet metal, i.e. may have a thickness of less than 1 centimeter.

In other words, the transmission can also be described as a dual transmission as follows. In addition, further very interesting and also advantageous design features emerge therefrom.

The dual transmission comprises two single transmissions arranged in parallel next to each other. The single transmissions are preferably each designed to transmit, in multiple stages, a rotational movement of a shaft, provided in each single transmission and driven by an electric motor, to a wheel half-axle, such as a universal (joint) shaft for example, as the respective output shaft, i.e. to two output shafts. The gears of a respective single transmission may be rotatable independently of the gears of the other single transmission. Preferably, all the gears are arranged in a contiguous space within the transmission case.

The transmission could thus in fact be split into a first (sub-)transmission and a second (sub-)transmission. In a manner of speaking, the transmission consists of two single transmissions in a common (overall) transmission case. The single transmissions are arranged parallel to each other. In terms of rotation, the two single transmissions or the first and second (sub-)transmissions are independent torque transmission units, particularly if an effective coupling via a wheel that can be driven by the (sub-)transmission across a pathway is ignored. The single transmissions are combined to form a dual transmission.

Via each single transmission, a rotational movement of a shaft to be driven can be transmitted via at least two stages to an output shaft. Each single transmission is intended to transmit a rotational movement of a shaft to be driven to a (separate) output shaft.

The dual transmission has a first output shaft and a second output shaft. The dual transmission has a first shaft to be driven and a second shaft to be driven. The two shafts to be driven can be operated independently of each other.

Each shaft to be driven is designed to be driven by an electric motor. The output shafts are intended to act on wheel half-axles, which are usually formed by wheel drive shafts having two joints, namely one joint in each end region of the wheel drive shaft. Each output shaft (indirectly) drives a wheel half-axle or a drive shaft leading to a wheel.

The rotational movement, which is introduced into the transmission by a shaft to be driven, can be applied to at least one of the (road) wheels via the output shaft. The transmission, which is a dual transmission, thus has a first shaft to be driven and a second shaft to be driven. Each shaft to be driven rotates at its own speed, depending on the drive by an electric motor. Each output shaft thus also has its own speed. For example, when the motor vehicle is traveling straight ahead, the speeds of the two output shafts should be as synchronous and as equal as possible if the (road) wheels have the same rolling radius. When cornering, however, it is helpful if the speed of one output shaft differs from the speed of the other output shaft. A speed control system is able to adapt or adjust a speed of at least one of the two electric motors so that, particularly in the case of different rolling radii, for example owing to different tire pressures, no torque is generated about a vehicle vertical axis and traveling in a straight line is ensured.

The two single transmissions that form the dual transmission are arranged parallel to each other, i.e. next to each other. Each single transmission extends in a contiguous space that is separated from the next space, this being the space for the single transmission. The space is located inside a transmission case. The gears of one transmission can rotate at a different speed than the gears of the other transmission. The gears of one transmission can be operated or rotated independently of the gears of the other transmission.

The dual transmission has a common spectacles-type bearing bracket as a component that is common to both output shafts, namely a first output shaft and a second output shaft. The spectacles-type bearing bracket, via its cuff around its ring-shaped internal opening, supports the respective output shaft extending into it at one end. In other words, the two output shafts, which in particular are arranged with a respective end face parallel to and opposite each other in the spectacles-type bearing bracket or the opening thereof, with the two end faces preferably being spaced apart from each other, lead out of the spectacles-type bearing bracket into a region outside the case of the dual transmission. The output shafts can in particular be supported together with the associated third gears. The bearings of the input shafts can also be supported. In other words, the spectacles-type bearing bracket may be a support structure for two output shafts, two bearings, such as rolling-element bearings or rolling-body bearings, in particular two barrel bearings, as well as two rotatable third gears, wherein at least one of the aforementioned components may be at least partially enclosed in a ring-like manner.

It is particularly advantageous if the spectacles-type bearing bracket is arranged centrally. The spectacles-type bearing bracket is located in the middle, so to speak, between two transmission case half-shells. From a different perspective, the spectacles-type bearing bracket is the central, middle component that separates the single transmissions of the dual transmission from each other. The spectacles-type bearing bracket divides the transmission chamber of the dual transmission into a left half and a right half (in the direction of travel). Across a boundary surface, which can be considered as a design aid, between the two halves of the dual transmission on which the spectacles-type bearing bracket extends, a flow or exchange of transmission oil takes place, but not a transmission of torque.

One component that can be assigned to the case is the spectacles-type bearing bracket, which from one perspective can be regarded as a partition element of the (sub-)transmission.

A spectacles-type bearing bracket, which may be provided in the dual transmission as a component thereof, may exist around a hole structure. The hole structure is in the center of the spectacles-type bearing bracket. The central hole, the hole structure, is designed to receive two ends of driven shafts, i.e. a first end of a first driven shaft and a second end of a second driven shaft.

Such a spectacles-type bearing bracket may be installed in a dual transmission of the type presented above.

For attachment purposes, the spectacles-type bearing bracket may have pin receptacles at its edges, i.e. in its edge regions. A suitable number of pin receptacles is, for example, four pin receptacles. Via these, torques that have been introduced, for example introduced via the driven shafts, can be dissipated to a case that carries the spectacles-type bearing bracket, such as the transmission case for example. Torques that would actually load the spectacles-type bearing bracket are thus dissipated via the case, for example via the sub-case thereof. Preferably at right angles to the pin receptacle, the spectacles-type bearing bracket has in particular flat contact surfaces. It is advantageous if the contact surfaces are in each case located opposite support surfaces in an inner region of the sub-case. In particular, three or four flat, ring-like contact surfaces may be provided on the spectacles-type bearing bracket, which together form parts of a smooth, geometric surface. All the pairs consisting of support surface and contact surface can be brought closer to each other until they touch. Two contact surfaces of the spectacles-type bearing bracket are located at a fixed distance opposite each other in the manner of a mirror image.

The spectacles-type bearing bracket centers around an elongate, cylindrical opening, into which two shafts can be inserted, each from one side of the spectacles-type bearing bracket. To this end, the spectacles-type bearing bracket has roller bearings, such as barrel bearings. The spectacles-type bearing bracket provides the lateral attachment for the respective driven shaft.

The receptacles for the driven shafts are located in the center of the spectacles-type bearing bracket. The spectacles-type bearing bracket is in turn attached to other case components. To this end, the spectacles-type bearing bracket has pin receptacles in its edge region, so that a connection between the spectacles-type bearing bracket and the case parts carrying the spectacles-type bearing bracket can be established via pins. In other words, pins serve to fix the spectacles-type bearing bracket on the transmission case. The pins may be subjected to shear stress by the spectacles-type bearing bracket during operation of the transmission. The spectacles-type bearing bracket may be a removable part of the transmission case. Removal of the spectacles-type bearing bracket is possible if both shells of the transmission case are separated from each other.

Owing in particular to the spectacles-type bearing bracket in the dual transmission, the dual transmission described above provides a good way of supporting and carrying the shafts that open out into the spectacles-type bearing bracket, in particular the output shafts. The dual transmission comprises two independent input shafts, one input shaft for each side of the dual transmission. The dual transmission comprises two output shafts, one output shaft for each side of the dual transmission. The input shafts and the output shafts protrude from the case. The first output shaft protrudes from the case in the opposite direction to the second output shaft. Similarly, the first input shaft protrudes into the case on a side and which from the other side is penetrated by the second output shaft. The respective input shaft and the associated output shaft are arranged at an equal height, i.e. at the same height.

The two output shafts are supported at the mutually facing ends by one and the same spectacles-type bearing bracket. In other words, the end faces of each output shaft face toward each other. One output shaft is located with its end face opposite the end face of the second output shaft. Torques introduced laterally into the axles can be dissipated to the case via the spectacles-type bearing bracket.

Further advantageous embodiments and further developments will be presented below which, considered per se, both individually and in combination, may likewise disclose inventive aspects.

A (virtual) mirror surface can be “drawn” through the entire case. This mirror surface separates the region of the first single transmission from the region of the second single transmission. The mirror surface runs through the spectacles-type bearing bracket. The mirror surface is referred to as a mirror surface because a reflection of the gears of the individual stages could be performed at this surface. A gear of the first sub-transmission or single transmission is located identically in the region of the second single transmission at the point equidistant from the mirror surface.

Advantageously, spur gears are used as gears of the transmission for a single transmission. The transmission is a transmission extending longitudinally in the direction of travel.

The individual gears of the gear stages mesh with each other; a transmission chain of gears starts at the input shaft and passes in stages, i.e. from gear to gear, until it reaches the region of the spectacles-type bearing bracket. When running through the gear stages in the output direction, there is a last gear stage that is provided directly in the region of the spectacles-type bearing bracket. The last gear stage opens out in the region of the spectacles-type bearing bracket.

However, the spectacles-type bearing bracket not only carries a respective output shaft at each end, i.e. more precisely two output shafts via its ends, but rather in one advantageous embodiment the spectacles-type bearing bracket is at the same time a mounting frame for two barrel bearings. The barrel bearings may be axially delimited by retaining clips. The two barrel bearings arranged in the spectacles-type bearing bracket can be held in position in a laterally delimited manner by the retaining clips holding the barrel bearings.

In one advantageous embodiment, the output shafts are supported by a single spectacles-type bearing bracket in an end region of the output shafts. The spectacles-type bearing bracket, which is referred to as “spectacles-type” because two output shafts are supported, could also be referred to as a monocle-type bearing bracket because the output shafts jointly extend longitudinally along a line such that the radii thereof overlap when viewed perpendicular to the case longitudinal direction. The spectacles-type bearing bracket preferably has a single, in particular central, hole structure. The hole structure preferably receives two respective driven shafts at one of their ends. The hole structure includes in particular two floating bearings. Each floating bearing can support one wheel half-axle, particularly when a shaft of the wheel half-axle extends into the transmission case. The spectacles-type bearing bracket is preferably attached to a support structure in the case interior. There is no need to provide sealing surfaces between the spectacles-type bearing bracket and the case. Such sealing surfaces could leak due to mechanical loads in continuous operation. The transmission may be equipped with a single sub-case connection surface.

In one advantageous embodiment, two barrel bearings are provided in the spectacles-type bearing bracket. Each barrel bearing is intended to receive one end of one of the output shafts. The respective barrel bearing receives one output shaft. With regard to an axial extension, such a barrel bearing can be referred to as an outermost (or innermost, depending on the viewing direction) bearing for a wheel half-axle or wheel drive shaft. In addition, a further bearing on the transmission case takes place via a ball bearing, such as a deep groove ball bearing.

It is advantageous if the spectacles-type bearing bracket is fixed to at least one sub-case of the transmission case via pins, which are preferably to be inserted into the spectacles-type bearing bracket in the edge region of the spectacles-type bearing bracket. The spectacles-type bearing bracket is mounted in a fixed position via the pins. Such a mounting is possible in a force-fitting or form-fitting manner.

In one advantageous further development, the spectacles-type bearing bracket is a removable structure, in particular because it is held only by pins, said structure having a single central hole. The spectacles-type bearing bracket can also be referred to as a single-hole support structure. The spectacles-type bearing bracket is fixed to the transmission case via pins. The hole in the spectacles-type bearing bracket is preferably arranged centrally in the spectacles-type bearing bracket.

In addition, it is advantageous if the spectacles-type bearing bracket, via at least one lubrication nozzle integrated therein, can discharge oil to the shafts carried therein. Such one or more lubrication nozzles may be arranged in such a way that they can introduce oil radially into the space in one hole of the spectacles-type bearing bracket. Depending on the flow rate, this can also be referred to as an injection, i.e. if an applied hydrostatic pressure is high enough to prevent the flow breaking down into a series of droplets. The lubrication nozzle or the lubrication opening is preferably supplied with transmission oil from a lubrication reservoir. In the lubrication reservoir, oil accumulates through an inflow of collected droplets or splashes. This is followed by a reservoir chamber. Splash oil is thrown from gears onto oil supply surfaces, inter alia. Gears that dip into a sump convey oil upward when splashing and release it as splashes. Splashes may also be droplets or may consolidate to form droplets under the effect of the surface tension.

The spectacles-type bearing bracket can also be compared to a web plate. A web plate of this type may be a shaped structure which laterally delimits the central opening and which, by way of its projected shape, retains the character of a single-hole support structure.

It is advantageously provided that just one single spectacles-type bearing bracket is formed as a support for two ends of the output shaft.

The spectacles-type bearing bracket carries the output shafts. The spectacles-type bearing bracket itself, in particular owing to its roller bearings, is designed as a floating bearing for each output shaft.

Viewed from one side, the spectacles-type bearing bracket looks like a rectangular plate that tapers toward its edges. In one advantageous embodiment, the plate that represents the spectacles-type bearing bracket tapers at least toward its edges. Webs protrude in some regions of the plate, which webs have a stabilizing effect on the bearing plate or spectacles-type bearing bracket. Further toward the outside, a drive gear can be arranged on each side of the spectacles-type bearing bracket.

The combinations and embodiments presented above can also be considered in numerous further connections and combinations.

In one embodiment, the spectacles-type bearing bracket may have a width such that it encloses and thus supports the respective ends of two individual shafts with equal width. The spectacles-type bearing bracket has a width that is more than twice as wide as one of the bearings for one of the shafts.

In an alternative embodiment, the spectacles-type bearing bracket may also be designed as a dual bearing for two shafts, the two shafts engaging one inside the other, for example concentric to each other, in order to be supported in the region of the spectacles-type bearing bracket in one case as an outer shaft relative to the spectacles-type bearing bracket and in one case as an inner shaft in the region of the spectacles-type bearing bracket opposite the outer shaft.

In addition, it is possible to design the input shaft(s) and/or the output shaft(s) as shafts which are likewise borne on sleeve-like hollow bodies, for example.

By way of example, consideration can also be given to using more than four bearings, in particular more than two bearing combinations, to attach the input shaft to the case, more precisely the case pans.

### BRIEF DESCRIPTION OF THE FIGURES

The present invention can be understood even better if reference is made to the accompanying figures which show particularly advantageous design possibilities by way of example, without limiting the present invention thereto, wherein

FIG. 1 schematically shows a motor vehicle with an electric drive,

FIG. 2 schematically shows a modified embodiment of a motor vehicle with an electric drive,

FIG. 3 shows a cross-section through a dual transmission,

FIG. 4 shows a second cross-section through the dual transmission, which is oriented perpendicular to the cross-section of FIG. 2,

FIG. 5 shows a plan view of a spectacles-type bearing bracket, with a section plane being indicated,

FIG. 6 shows a cross-sectional view according to FIG. 5,

FIG. 7 shows a perspective view of the spectacles-type bearing bracket, and

FIG. 8 shows an exploded view of an arrangement, in particular of a spur gear as an output gear (see FIG. 3), between a removable spectacles-type bearing bracket and a transmission sub-case.

### DESCRIPTION OF THE FIGURES

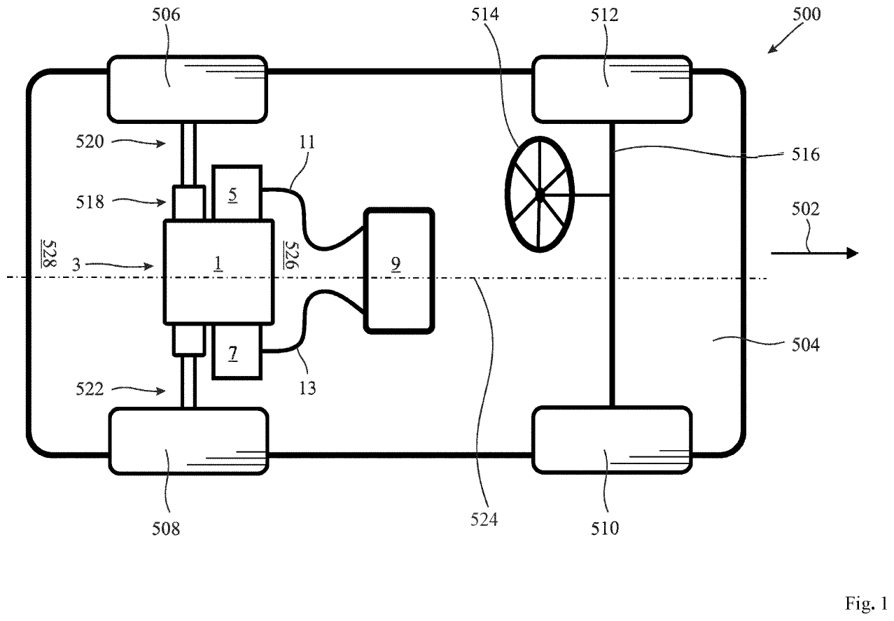

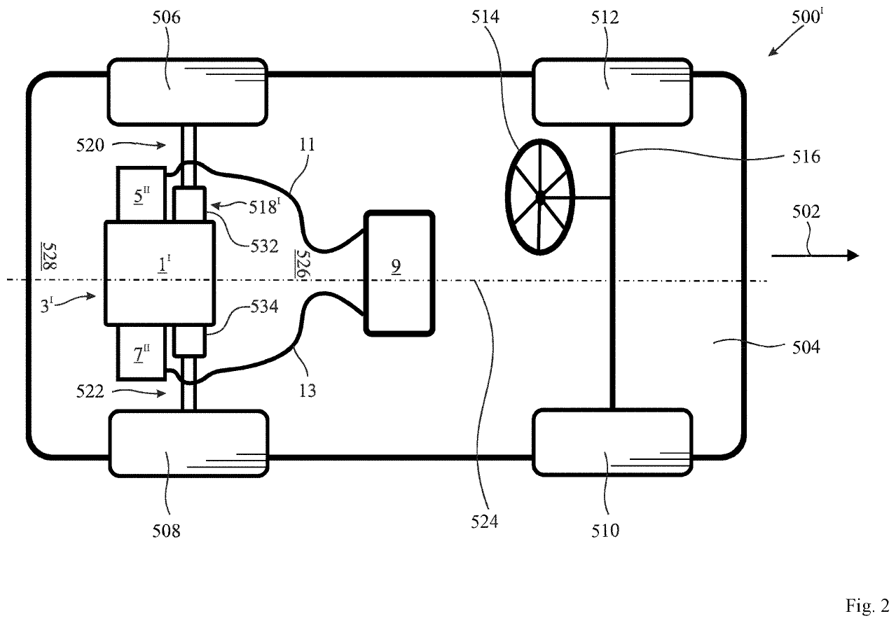

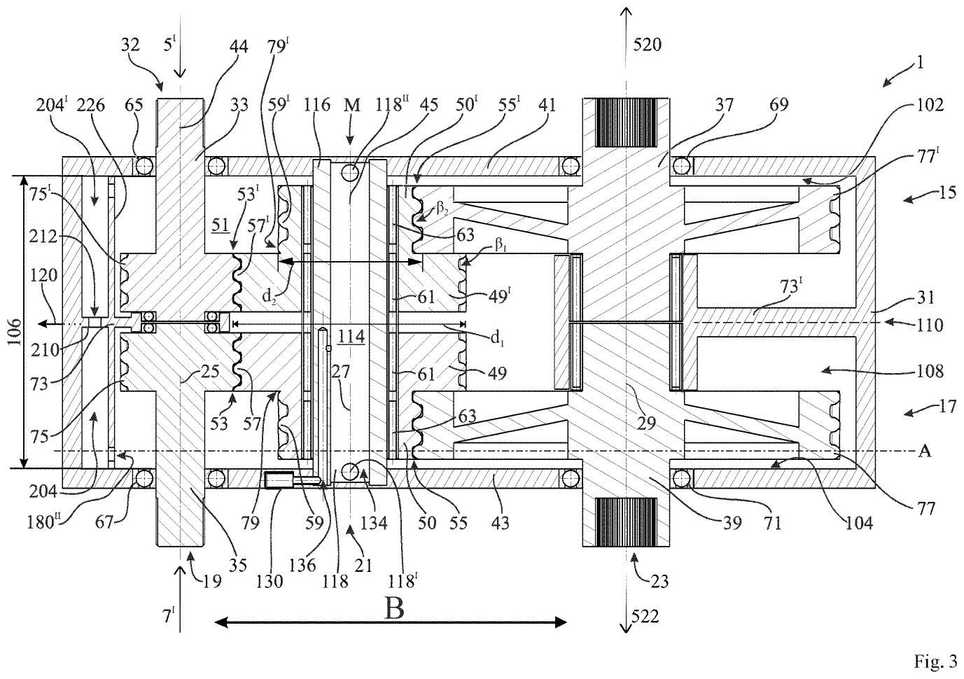

FIG. 1 and FIG. 2 schematically show a motor vehicle 500 or 500^{I} which, in addition to the space for the driver, which is identifiable by the steering wheel 514 and can also be referred to as the driver's cab or passenger compartment, has a rear 526 and a trunk region 528, identifiable by the marked direction of travel 502. Located in the front part of the passenger compartment, as usual, is the steering wheel 514, which can transmit a driver's steering movements to two wheels as road wheels 510, 512 or vehicle wheels 510, 512 via a steering linkage 516 consisting of a steering shaft, a steering transmission, track rods and wheel steering levers. Two further road wheels 506, 508 are mounted on a second axle, the vehicle rear axle 518 or 518^{I}. The road wheels 506, 508 are driven via half-axles 520, 522. The half-axles 520, 522 may be formed by universal (joint) shafts, for example. The half-axles 520, 522 are attached to the output side of a dual transmission 1 or 1^{I}. A first electric machine 5 or 5^{II} and a second electric machine 7 or 7^{II} are attached to the drive side of the dual transmission 1 or 1^{I}. The electric machines 5, 7 or 5^{II}, 7^{II} and the half-axles 520, 522 are each attached in pairs to the same sides of the transmission 1 or 1^{I}. Torque from the electric machine 5 or 5^{II} is applied to an input shaft 33 (see FIG. 3) of the dual transmission 1 or 1^{I} via a respective side, and the first half-axle 520, and thus the output to the first road wheel 506, is attached on the same side of the transmission 1 or 1^{I}. In the same way, torque from the electric machine 7 or 7^{II} is applied to an input shaft 35 (see FIG. 3) of the dual transmission 1 or 1^{I}, and the second half-axle 522, and thus the output to the second road wheel 508, is arranged on the same side of the dual transmission 1 or 1^{I}.

A particularly advantageous motor vehicle body exists if the electric machines 5, 7, which in FIG. 1 are mounted in front of the half-axles 520, 522 in the direction of travel 502, are mounted behind the half-axles 520, 522 as shown on the basis of the electric machines 5^{II}, 7^{II} in FIG. 2, for example in that the symmetrically constructed dual transmission 1 is rotated through 180° in the illustrated plane of the vehicle floor 504 of FIG. 1 and in particular mounting points for the dual transmission 1 and the electric machines 5, 7 are provided underneath the trunk 528. As shown in FIG. 2, however, a powertrain 3^{I} comprising a dual transmission 1^{I} can also be constructed in a motor vehicle 500^{I}, the gears (see FIG. 3) of said transmission being designed to transmit power in an arrangement of the electric machines 5^{II}, 7^{II} behind a rear axle 518^{I}.

According to FIG. 1 and according to FIG. 2, an electric accumulator 9 is located in the region of the vehicle floor 504, which accumulator, via electrical leads 11, 13, can provide electrical energy to the electric machines 5, 7 or 5^{II}, 7^{II} and the motor controls thereof (not shown). The powertrain 3 or 3^{I} thus extends from the accumulator 9, via the electrical leads 11, 13, via the electric machines 5, 7 or 5^{II}, 7^{II} and the motor controls thereof, via the dual transmission 1, and via the half-axles 520, 522, to the road wheels 506, 508. Each electric machine 5, 7 or 5^{II}, 7^{II} thus drives one road wheel 506, 508. This is a single-wheel drive.

The transmission 1 or 1^{I} is arranged on the vehicle longitudinal axis 524. One electric machine 5 or 5^{II} and one half-axle 520 are located on one side of the vehicle longitudinal axis 524, while the other electric machine 7 and the other half-axle 522 are arranged on the other side of the longitudinal axis 524. The electric machine 5 or 7, which according to FIG. 1 is arranged close to the center and rotates transversely to the vehicle longitudinal axis 524, rotates the transmission 1 so that, on the output side, an output shaft 37, 39 (see FIG. 3) can apply a torque to a wheel 506 or 508 likewise transversely to the vehicle longitudinal axis 524. The electric machine 5^{II} or 7^{II}, which according to FIG. 2 is arranged close to the trunk and rotates transversely to the vehicle longitudinal axis 534, rotates the transmission 1^{I} so that, on the output side, an output shaft 37, 39 (see FIG. 3) can apply a torque to a wheel 506 or 508 likewise transversely to the vehicle longitudinal axis 524. As shown in FIG. 1 or FIG. 2, for such a drive connection, the electric machine 5, 7 or 5^{II}, 7^{II} is attached to the input shaft 33, 35 (shown in FIG. 3) by a coupling 532, 534. The transmission 1 or 1^{I} and the electric machines 5, 7 or 5^{II}, 7^{II} are coupled.

The vehicle 500 or 500^{I} shown in FIG. 1 or FIG. 2 is driven via its vehicle rear axle 518 or 518^{I}. This is an electric rear axle drive using the dual transmission 1 or 1^{I}. The dual transmission 1 or 1^{I} is arranged in the region of the rear compartment 526 or in the region of the trunk 528, and in each case in the region of the vehicle floor 504.

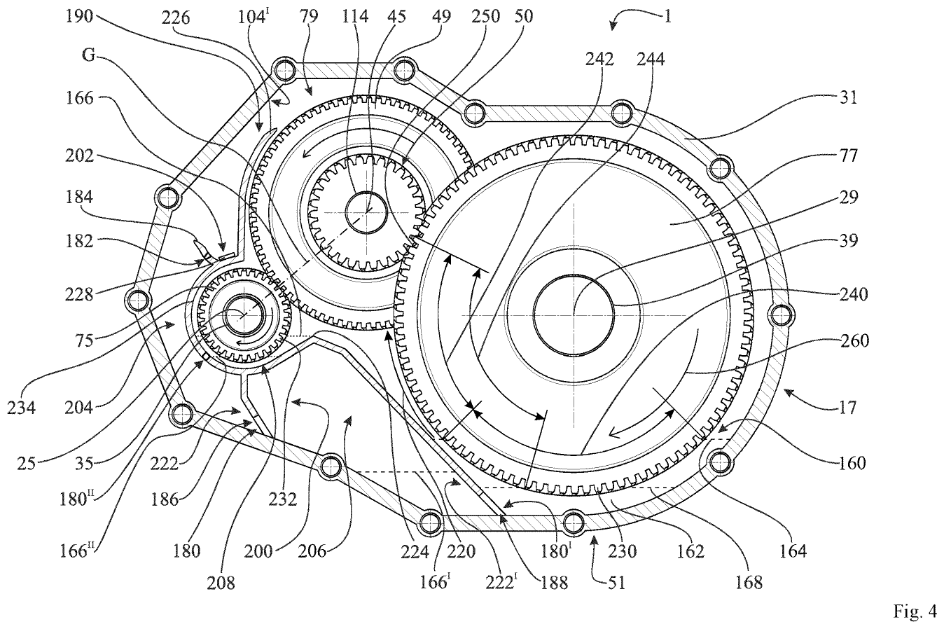

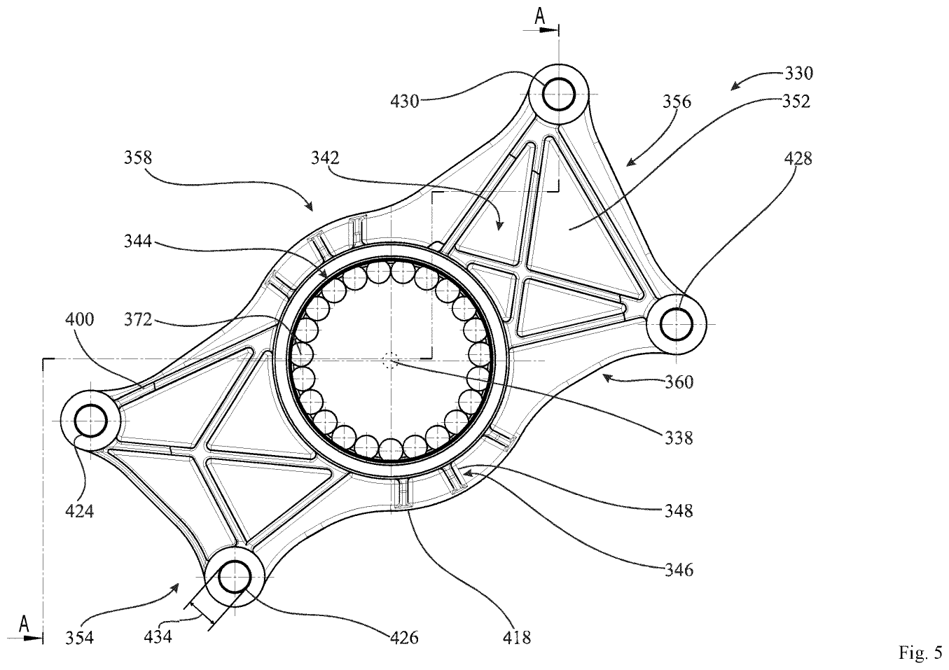

Interesting aspects of the dual transmission 1 will be explained below primarily on the basis of FIG. 3 and FIG. 4. It is particularly helpful to consider the two figures, FIG. 3 and FIG. 4, jointly with the following text. FIGS. 5 to 8 are to be included in addition to what is stated below because advantageous aspects or components and arrangements, by which a transmission can be further developed, will also become apparent from these figures.

The transmission 1 is shown in a sectional view in FIG. 3, in which the section is made through the individual gear centers 25, 27, 29.

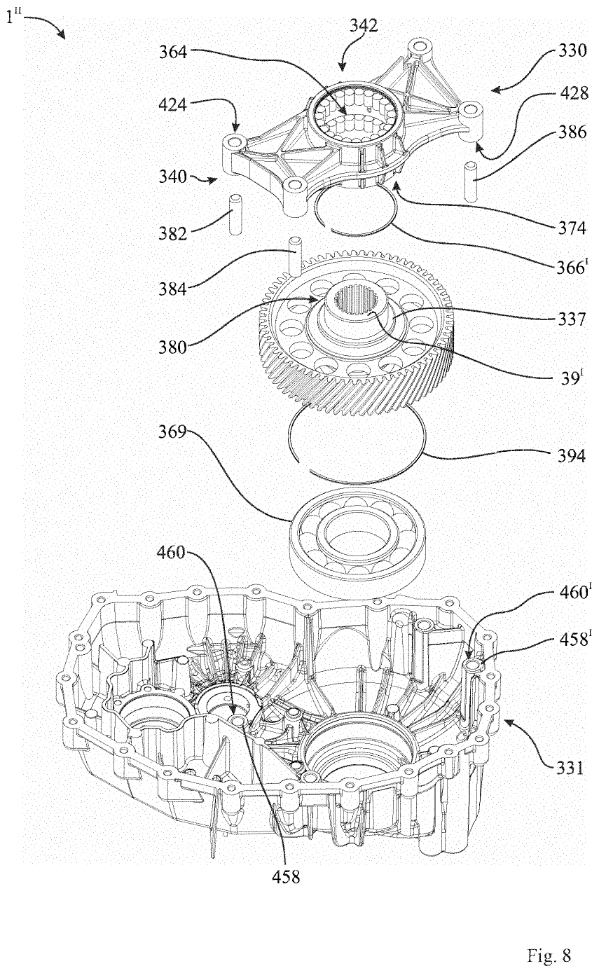

As already discussed above, the dual transmission 1 shown in greater detail in FIG. 3 is shown in FIG. 1 in an installation position on the vehicle longitudinal axis 524 of a vehicle, such as the vehicle 500, in order to drive two wheels 506, 508 individually. The dual transmission 1 thus forms part of an electrically powered motor vehicle 500, more precisely the powertrain 3 thereof. The transmission 1^{I} of FIG. 2 can be designed in the manner of a transmission 1 according to FIG. 3 or in the manner of a transmission 1^{I} according to FIG. 8, the transmission case in each case having attachment points for mounting it in the vicinity of the trunk (not shown).

As shown in FIG. 3, the dual transmission 1 has two single transmissions 15, 17, each single transmission 15, 17 being designed as a two-stage spur gear transmission. Each spur gear transmission has three positions 19, 21, 23 for gear centers 25, 27, 29 in a single, common transmission case 31. A drive torque 5^{I}, 7^{I} is applied by the electric machines 5, 7 (see FIG. 1) to the respective input shaft 33, 35. The input shafts 33, 35 connected to the respective electric machines 5 and 7 (see FIG. 1) and the output shafts 37 and 39 connected to the respective half-axles 520 and 522 are arranged at the same height in a middle region M in relation to a transverse extension, i.e. in particular a relatively short distance from one case wall 41 to an opposite case wall 43 of the transmission case 31. The position of the input shafts 33, 35 and of the output shafts 37, 39, which define the gear centers 25 and 29, describes a reference plane B within the transmission case 31. A middle axle 45, which describes the gear center 27 or a position that is a middle gear center, is in a parallel and elevated position relative to the reference plane B and forms a position of the gear center 27 at a distance from the transmission case bottom.

The two input shafts 33, 35 are combined to form a dual input shaft 32. They are mechanically connected to form the dual input shaft 32. The two input shafts 33, 35 extend along the axis 44 and in this way form the dual input shaft 32. The two coaxially arranged input shafts 33, 35 are connected to each other in such a way as to be rotatable relative to each other.

The middle axle 45 can be intersected by a straight line G (see FIG. 4) connecting the gear center 25 or 29 and the middle axle 45, namely in an angle range of around 5° to 70° in relation to a connecting line, intended as a design aid, between the gear centers 25 and 29.

As can likewise be seen from FIG. 3, the way in which the gear centers 25, 27, 29 are to be located depends on the on the gears 75, 75^{I} of the input shafts 33, 35, the gears 77, 77^{I} of the output shafts 37, 39 and the gears 49, 49^{I}, 50, 50^{I} of the toothing geometries selected on the middle axle 45, as well as on the powers to be transmitted. On account of being driven by the drive torques 5^{I}, 7^{I}, the gears 75, 75^{I} are the first gears in the flow of torque through the transmission 1.

The respective gear 75, 75^{I} on the input shaft side of each single transmission 15, 17 drives a respective gear 49, 49^{I} on the middle axle 45. In the exemplary embodiment shown, the directions of rotation of the electric machines 5, 7 (see FIG. 1) in the traction mode of the vehicle are selected in such a way that the gear 49, 49^{I} has a direction of rotation rotating away from the case bottom 51 of the transmission case 31 following gear contact in a driving manner.

If, in a manner differing from the advantageous motor vehicle body shown in FIG. 1 and described in this connection, a motor vehicle body is realized with a transmission arrangement as shown in FIG. 2, in which the transmission arrangement is turned through 180° in comparison to the transmission arrangement in FIG. 1, then a direction of rotation rotating toward the case bottom 51 of the transmission case would be set for the gear 49, 49^{I} following gear contact.

According to FIG. 3, when a transmission case 31 of the transmission 1 is in an installed state in a motor vehicle (see motor vehicle 500 or 500^{I} in FIG. 1 or FIG. 2), the case longitudinal direction 120 is oriented parallel to the vehicle longitudinal axis (see vehicle longitudinal axis 524 in FIG. 1 or FIG. 2). The transmission case 31 has a greater extension in its case longitudinal direction 120 than in its width 106.

As illustrated in particular in FIG. 3, the axle 45 defining the middle position or the middle gear center 27 is designed as a stationary axle which is fixed to the case. This makes it possible to stiffen the transmission case 31 without the need for additional components. The respective output gear 49, 49^{I} on the axle 45 and the driving gear 50, 50^{I} are borne on the axle 45 via in each case two needle bearings 61, 63 in order to avoid any tilting of the gears 49, 49^{I}, 50, 50^{I}, which are moreover preferably formed as a one-piece stepped gear.

In contrast, the input shafts 33, 35 and the output shafts 37, 39 are mounted by way of rolling bearings 65, 67, 69 and 71 in outer walls of the transmission case 31. Furthermore, the input shafts 33, 35 are mounted by means of ball bearings in the vicinity of a case partition wall 73 that has apertures, such as the aperture 212, for the joint lubrication of the single transmissions 15 and 17. A wall support 210, designed as part of the case partition wall 73, establishes a connection to the transmission case 31. The output shafts 37 and 39 are mounted in a second case partition wall 73^{I}, more precisely a spectacles-type bearing bracket, by means of needle bearings (without reference signs) or one needle bearing per single transmission 15, 17.

As can be seen particularly well from looking at the sub-transmission 17 shown FIG. 4, the input shaft 33 and the output shafts 39 are arranged lower than the axle 45 in relation to the case bottom 51 of the transmission case 31.

The stepped gears, such as the stepped gear 79 on the axle 45 (see FIG. 3), have a first, larger diameter d₁ on the drive side and a smaller, second diameter d₂ on the output side. There is a step-down ratio toward the output side. The two gears 49, 50 are joined together to form a stepped gear 79. It can also be said that the two gears 49, 50 or 49^{I}, 50^{I} are welded together to form a stepped gear 79 or 79^{I}. Accordingly, a second gear pair 49^{I}, 50^{I} is mounted as a stepped gear 79^{I}. Depending on the manner of counting, gear pairs 49, 50; 49^{I}, 50^{I} which are arranged for conjoint rotation, such as the stepped gear 79, can be referred to as second gears or as second (50, 50^{I}) and third gears (49, 49^{I}).

In the dual transmission 1 according to the invention, as shown in FIG. 3, a first gear stage 53 or first ratio 53 is created, which forms a ratio turning away from the case bottom 51 of the transmission case 31, as well as a second gear stage 55 or the second ratio 55, which forms a ratio turning toward the case bottom 51. On the other hand, the gear pairing consisting of the first two gears 75^{I}, 49^{I} in the flow of torque in the transmission 1 creates the ratio 53^{I}. The gear pairing consisting of the subsequent two gears 50^{I}, 77^{I} creates the ratio 55^{I}.

As shown in particular by FIG. 3 in a schematic longitudinal section through the dual transmission 1, the middle gears 49, 50 or 49^{I}, 50^{I}, which are formed in one piece with each other, are designed to transmit a torque in a manner free of transverse forces due to the fact that the teeth 57 and 59 or 57^{I} and 59^{I} of two adjacent gears 49, 50 or 49^{I}, 50^{I} are provided with different angles of inclination for each row of teeth, such as the angles of inclination β₁ and β₂. The angles of inclination β₁, β₂ are indicated only schematically in the illustrated section plane of FIG. 3. The teeth 57, 59 in the sub-transmission 17 as well as adjacent teeth of the respective rows of teeth (without reference signs) extend with respective tooth directions in a parallel manner through the section plane of FIG. 3. In relation to a specified or selected direction of the middle axle 45, the teeth 57, 59 or the running surfaces thereof extend with a tooth direction laterally toward the other sub-transmission 15 or away from the other sub-transmission 15, wherein a deviation, expressible by vectors, of the tooth directions of the teeth 57, 59 from the direction of the middle axle 45 in each case has the same sign (identical sign in the angles of inclination).

For the gears 49^{I}, 50^{I} and the teeth 57^{I}, 59^{I} of the other single transmission 15, the same applies on account of an identical design of transmission parts, i.e. the sub-transmission 15, which is constructed in a manner identical to the sub-transmission 17, has adjacent gears 49^{I}, 50^{I} which are designed with a corresponding inclination of the teeth 57^{I}, 59^{I}. In other words, what has been described above correspondingly applies to the gears 49^{I}, 50^{I} and the teeth 57^{I}, 59^{I} of the other single transmission 15 due to an identical design of transmission parts.

The gears 49, 50 or 49^{I}, 50^{I} are free of axial forces, at least in the traction mode of the vehicle.

It may be advantageous to provide thrust washers to support the gears 49, 50 or 49^{I}, 50^{I} on the transmission case 31.

Furthermore, in order to vent the transmission case 31, instead of a solid middle axle it may be advantageous to provide the middle axle 45 as a sleeve or to additionally provide a sleeve on the middle axle 45, which sleeve makes it possible to equalize the pressure in the transmission case 31.

The gears 49, 49^{I}, 50, 50^{I}, 75, 75^{I}, 77 and 77^{I} are formed as disk wheels on account of the high torques to be transmitted. As shown in FIG. 3, the gears 77, 77^{I} on the output shaft side are formed by a disk that has a thickness smaller than the width of their gear rim. In addition, the respective disk of the gears 77, 77^{I} is at an angle to the respective output shaft 37, 39, i.e. it may be formed at a non-perpendicular angle to the respective output shaft 37, 39. The disk has a base with an end face that extends radially from the output shaft 37, 39 or merges into the output shaft 37, 39 and in particular bounds a running surface of a needle bearing in an axial direction.

All the gears 49, 49^{I}, 50, 50^{I}, 75, 75^{I}, 77, 77^{I}, axles and shafts 33, 35, 37, 39 installed in the transmission case 31 are lubricated via a common sump (see FIG. 4). Each single transmission 15, 17 has a step-down ratio of, for example, 8.5:1 or even 12:1.

In a regular filling state, the transmission case 31 is filled with a transmission oil, but not completely filled with oil; instead, part of the interior, i.e. part of the internal volume 108 of the transmission case 31 is filled with air.

By way of its internal cavity, the transmission 1 shown in FIG. 3 with its transmission case 31 creates an internal volume 108 that extends from the first inner side 102 thereof to the second inner side 104 thereof. However, volume-reducing components are arranged in the internal volume 108. One component that reduces the internal volume 108 is an oil-guiding wall 226. The internal volume 108 is partly reduced by the gears, such as the gears 49, 49^{I}, 50, 50^{I}, 75, 75^{I}, 77, 77^{I}, by shafts, such as the shafts 33, 35, 37, 39, and by other components, such as needle bearings 61, 63 and rolling bearings, as well as by a sleeve 116. The free internal volume 108 is reduced by the installed components. The remaining internal volume 108 is filled to a certain level with a transmission fluid, such as a transmission oil, for operating the transmission 1. Air remains in the rest of the internal volume 108.

The internal volume 108 is partly split into chambers. The oil-guiding wall 226 separates regions of the internal volume 108 from each other. The oil-guiding wall 226 is connected to the transmission case 31. Provided in the region of a center 110 of the transmission 1 is the wall support 210 of the oil-guiding wall 226, which at the same time is designed as a bearing support for two shafts 33, 35. The wall support 210 separates a collection chamber 204^{I} of one single transmission 15 from a collection chamber 204 of the other single transmission 17. In the wall support 210, at least one equalizing flow opening 212 ensures an equalization of the level of transmission oil in the collection chambers 204, 204^{I} between the single transmissions 15, 17.

In other words, the single transmissions 15, 17 are decoupled from each other in terms of torque transmission, but are coupled to each other in terms of lubrication. A needs-based lubrication of the transmissions takes place through separate, but oil-permeable, regions of the internal volume 108 with the aid of delay means for a flow of transmission oil, such as the delay means 180^{II}, as will be explained in greater detail below.

For air that is to pass outward via a bore 118 in the sleeve 116 to a breather cap 130 in order to be discharged, a vent structure is incorporated in the transmission 1.

The sleeve 116, which is hollow due to a bore 118, is located in the region of the gear axle 114 among the gear pairs 49, 50 or 49^{I}, 50^{I} designed as stepped gears 79. The cavity created by the bore 118 in the interior of the sleeve 116 has connections to the rest of the internal volume 108 of the transmission 1^{I} or of the transmission case 31 via further bores 118^{I}, 118^{II}.

The sleeve 116 extends from one inner side 102 to the opposite inner side 104 of the transmission case 31. The sleeve 116 is a transverse strut that stiffens the case 31. The (internal) width 106 of the transmission case 31 is completely spanned by the sleeve 116. The sleeve 116 therefore extends from a first case wall 41 to a second case wall 43.

Advantageously, the sleeve 116 is located in a middle region M of the transmission 1. The middle region M of the transmission 1 is used by the second, middle position 21 to center gears 49, 49^{I}, 50, 50^{I}.

Via the (feed) bores 118^{I}, 118^{II}, air from the internal volume 108, namely from anywhere therein so long as it is somehow distributed over the width 106, can enter the centrally arranged bore 118 of the sleeve 116, which in particular spans the width 106 of the case 31. The air then passes to the breather cap 130. The case wall 41, 43 may contain further bores (not shown), which extend partially along the case wall 41, 43 and via which air enters the bore 118 that spans the width 106 of the case 31. Such bores in the case wall also serve to supply oil to the needle bearings of the gears 49, 49^{I}, 50, 50^{I}.

As can be seen from looking at the details of FIG. 3, a narrower portion 136 is connected to the thicker portion 134 outside of the center 110 of the transmission 1. The narrower portion 136 of the vent extends over less than half the distance of the sleeve 116, in particular in the width direction.

FIG. 4 schematically shows, along a broken line A, a cross-section through the dual transmission 1, which was shown in a different sectional view in FIG. 3. The two section planes, that of FIG. 3 and that of FIG. 4, are perpendicular to each other. FIG. 4 shows a sectional view through the second sub-transmission 17. For better clarity, some details from FIG. 3, such as the sleeve 116, which have already been explained in detail on the basis of FIG. 3, are shown in simplified form in FIG. 4.

A corresponding section through the first sub-transmission 15, which is likewise shown in FIG. 3, would show a structure identical to that of FIG. 4. In FIG. 4, the sub-transmission 17 is surrounded by the transmission case 31. A first gear 77, having a gear center 29 arranged on the output shaft 39, and a further gear 50, which can be referred to as the second gear, are shown. The first gear 77 meshes with the second gear 50, which is seated on the stationary gear axle 114 or on the middle axle 45. The second gear 50, together with a third gear 49, forms a stepped gear 79. In the illustrated design of the dual transmission 1, it can also be said that the gear axle 114 is arranged higher than the output shaft 39, which is arranged at the same level as the input shaft 35 in relation to a vehicle footprint or a road (not shown). By way of example and to illustrate the geometry, the centers 25 and 45 are connected by a dash-dotted straight line G. The input shaft 35 carries a fourth gear 75, which meshes with the third gear 49. The stepped gear 79 arranged on the gear axle 114 is lubricated indirectly.

Hereinbelow, the description will focus on individual aspects of the lubrication, in particular the oil lubrication.

The transmission sump 160 is located in a bottom region of the dual transmission 1. The bottom region is also referred to as the sump 160 because it accommodates the lubricant 162 in the case 31 when the dual transmission 1 is in a rest state. A first lubricant level 164 of the sump 160 is set. The lubricant level 164 can also be referred to as the fill level. A first gear segment 240 of the first gear 77 dips into the lubricant 162. When the dual transmission 1 is set in rotation by a motor drive, for example to move the motor vehicle 500 or 500^{I} shown in FIG. 1 or FIG. 2 in a forward direction, the first gear 77 moves with a direction of rotation 260. Splash teeth, such as the first splash tooth 230, rotate with the gear 77 through the sump 160 and convey lubricant 162 upward. A second gear segment 242 has to move past the second gear 50 before lubricant 162 that is conveyed by the first gear 77 can reach the second gear 50 or the running surface 250 of the gear through transportation. The excess lubricant 162 transferred from the first gear 77 to the second gear 50 is transported onward before being removed by centrifugal forces. As a result, during a driving mode, the lubricant 162 in the sump 160 is gradually lowered from the first lubricant level 164 to a lower lubricant level 168, which can also be referred to as the third lubricant level. At the same time, the second gear segment 242 thus lengthens by a significant length, namely to a third gear segment 244, i.e. to this gear segment 244 that must be traveled until lubricant 162 from the sump 160 arrives at the second gear 50. In other words, when the lubricant level 168 is lowered, the time taken until lubricant 162 is drawn up to the second gear 50 is extended.

Meanwhile, the fourth gear 75 draws lubricant 162 upward from a gear lubrication pan 208 by means of second splash teeth, such as the second splash tooth 232, with a direction of rotation identical to the first gear 77 with its direction of rotation 260. The direction of rotation 260 refers to one of two possible directions of rotation of the gear 77. The lubricant 162 from the gear lubrication pan 208 is at least partially transferred to the third gear 49. In a rest state of the dual transmission 1, the gear lubrication pan 208 has a second lubricant level 166, the height of which is limited by a flow-off barrier 224 of the gear lubrication pan 208. The second lubricant level 166 can be lowered to another, lower lubricant level 166^{II} by the delay means 180^{II}, preferably in the form of an electromechanically closable shutter opening in a gear lubrication wall 208. The gear lubrication pan 208 and the oil collection pan 234 that adjoins it in a vertical direction are formed as regions of the oil-guiding wall 226. The oil collection pan 234 is located in an angular range around the input shaft 35 and around the gear 75 arranged on the input shaft 35 (see FIG. 3), catches peripheral oil splashes, i.e. oil splashes not directed toward a gear, and routes said oil into the gear lubrication pan 208. Transmission oil can be discharged from the gear lubrication wall 208 into the collection chamber 204 in a controlled manner. As the input shaft 35 rotates, energy losses caused by splashing can thus be kept low. The delay means 180^{II} is preferably closed when the transmission is at a standstill. Such a two-level transmission oil system 164, 166, 166^{II}, 168, in particular a dual-level transmission oil system, of a single transmission 17 enables rapid lubrication of the stepped gear 79, for example at the time of transmission start-up, from two different directions, i.e. from a drive side or a side of the input shaft 25 and from an output side or a side of the output shaft 39.

By means of centrifugal forces, excess lubricant 162 that is drawn upward to the stepped gear 79 is supplied at least partially in droplet form to a gravity run-off path 190. The gravity run-off path 190 extends along an inner side 104^{I} of the transmission case 31. Located between the inner side 104^{I} and the oil-guiding wall 226, which partially surrounds the gears 49, 75 and 77, is a system consisting of a plurality of chambers arranged one after the other in the direction of gravity, i.e. a chamber system 200 which has a plurality of delay means, such as the delay means 180, which is a wall constriction, or the delay means 180^{I}, which is a flow valve 188, for a lubricant run-off. The oil-guiding wall 226 has the shape of a scraper at its upper end, so that lubricant 162 can be stripped by the scraper from the gear 49 moving past. A first chamber is the drip chamber 202, in which lubricant droplets are collected. The drip chamber forms an uppermost chamber in a vertical sequence of chambers. Collected lubricant is separated from abraded metal material by a separating magnet 228 at the bottom of the drip chamber. Lubricant that has thus been cleaned is supplied in droplet form, via a nozzle 182 in conjunction with a shutter 184, to the collection chamber 204. The expression “in droplet form” also encompasses the situation where the oil may be supplied as a narrow flow; no particular droplet shape of the lubricant is required. The separating magnet 228 prevents clogging of the nozzle 182. The shutter 184 prevents oil droplets from passing directly downward from the inner side 104^{I}. Droplets from the nozzle 182 enter the collection chamber 204. A reservoir of lubricant can accumulate in the collection chamber 204. The collection chamber as a middle chamber can thus also be referred to as a first reservoir chamber. The collection chamber 204 has a wall portion which can be referred to as a discharge-side part 222 and forms a flow-off choke 186. From the collection chamber 204, the lubricant 162 enters the reservoir chamber 206. The reservoir chamber 206, which can also be referred to as the second reservoir chamber 206, is a lowermost chamber of the multi-chamber system 200. The reservoir chamber 206 is equipped with the flow valve 188 in its discharge-side part 222^{I}. A return flow of lubricant 162 into the sump 160 can be at least intermittently blocked by the flow valve 188, which forms a delay means 180^{I}. The delay means 180, 180^{I} thus described ensure that the third lubricant level 168 has a height sufficient for lubricating the dual transmission 1, while ensuring that energy losses caused by a stirring of the first gear 77 in the sump 160 are kept as low as possible. By way of the delay means 180^{I}, i.e. by way of the flow valve 188, the second lubricant level 166^{I} in the reservoir chamber 206 may decrease toward the lubricant level 168, provided that the lubricant level 168 is below the second lubricant level 166^{I}. Thanks to the delay means 180^{I}, an equalization of the lubricant level takes place between the lubricant level 168 present in the sump 160 and the second lubricant level 166^{I} present in the reservoir chamber 206. The first lubricant level 164 encourages a rapid, pump-free distribution of oil when starting up the dual transmission 1. It is thus possible to equip the teeth 77, 50, 49, 75 with a surface lubrication 220 by a lubricant 162.

With reference to FIGS. 5 to 8, which will be discussed jointly, a spectacles-type bearing bracket 330 and the installation thereof in a transmission 1^{II} (see FIG. 8) will now be described:

FIG. 5 shows one possible embodiment of a spectacles-type bearing bracket 330, which can be installed as a component in a dual transmission 1^{II} (for example according to FIG. 8 or FIG. 3). The spectacles-type bearing bracket 330 (see FIG. 3) has a first narrow side 354 opposite a second narrow side 356. The narrow sides 354, 356 are adjoined by a first plate long side 358 and a second plate long side 360 when moving round the spectacles-type bearing bracket 330 along an edge 418. The sides 354, 356, 358, 360 form curved boundaries of the web plate 352. They form part of the spectacles-type bearing bracket 330 in the manner of a web plate edge. The web plate 352 has in its rounded corner regions a first pin receptacle 424, a second pin receptacle 426, a third pin receptacle 428, and a fourth pin receptacle 430. Two opposite pin receptacles arranged diagonally opposite each other in relation to a flat extension of the spectacles-type bearing bracket 330, namely the first pin receptacle 424 and the third pin receptacle 428 or the second pin receptacle 426 and the fourth pin receptacle 430, are supported in each case diagonally opposite each other as an attachment structure that is thicker than the web plate 352. The attachment structure is part of a stiffening of a plate plane of the web plate 352.

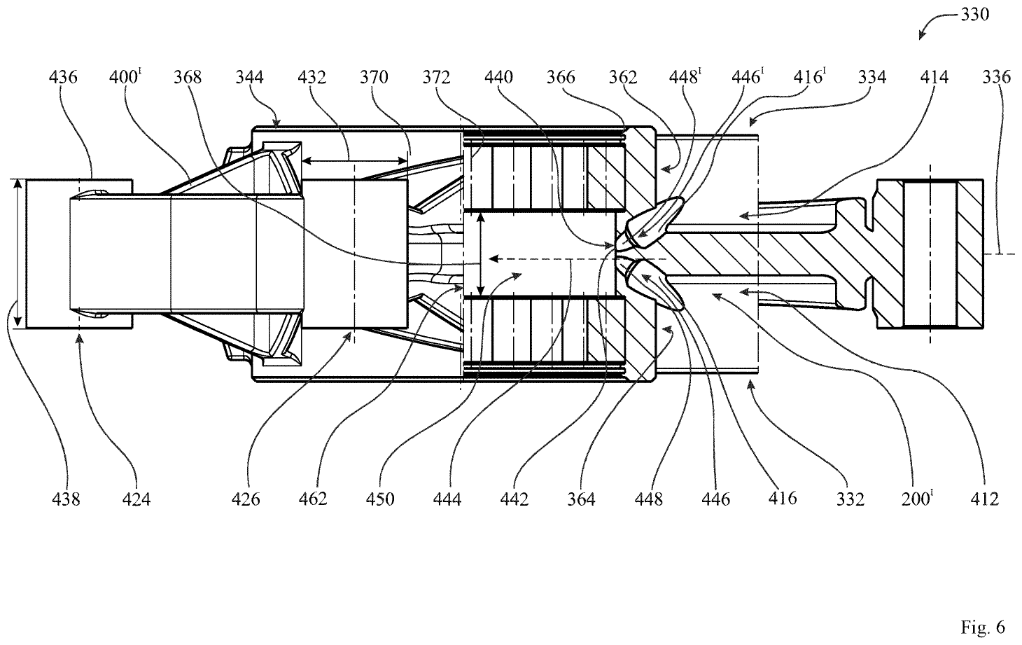

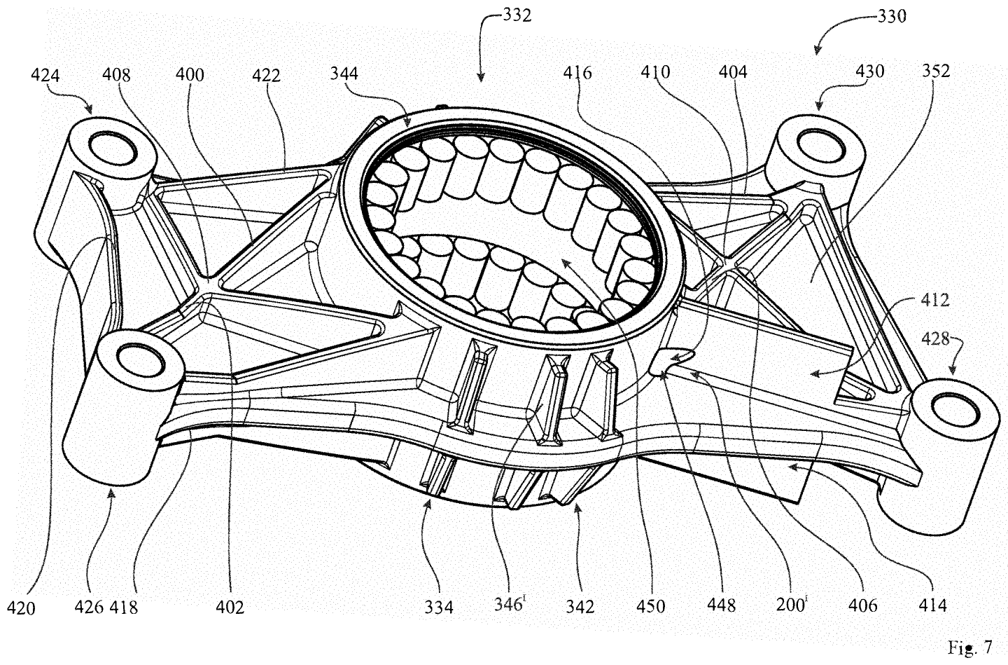

The spectacles-type bearing bracket 330 has a circular hole structure 344 approximately in the center between the pin receptacles 424, 426, 428, 430. The hole structure 344 is provided as a continuous opening with a stepped wall through the web plate 352. The hole structure 344 defines an orientation of shafts to be attached, such as the output shafts 37, 39 shown in FIG. 3. An output direction 338 in the dual transmission (see dual transmission 1 of FIG. 3) is thus specified. The hole structure 344 together with the webs 400, 400^{I}, 402, 404, 406 protruding from the spectacles-type bearing bracket 330 (see also FIG. 6 and FIG. 7) form a single-hole support structure 342. The single-hole support structure 342 has bosses and overhangs formed in one piece with the web plate 352. The single-hole support structure 342 has a plurality of hole structure supports, such as the hole structure support 346, which each extend radially away from the hole structure 344. A support collar 348 of the hole structure supports 346 ensures particularly good stabilization of the spectacles-type bearing bracket 330 in a tangential direction around the hole structure 344.

As a further measure to mechanically stabilize the spectacles-type bearing bracket 330, the web plate 352 is strutted by a plurality of webs, such as the first web 400. The webs 400 can also be referred to as web plate thickenings.

Located in the hole structure 344, in particular lined up next to each other in a ring-shaped arrangement, is a plurality of identical barrel rolling elements, for example the barrel rolling element 372.

The section line A-A in FIG. 5 shows where the spectacles-type bearing bracket 330 according to FIG. 5 is to be cut in order to achieve the cross-sectional view show in FIG. 6.

Inter alia, it can be seen in FIG. 6 that the spectacles-type bearing bracket 330 is largely mirror-symmetrical and has a first spectacles-type bearing bracket side 332 and a second spectacles-type bearing bracket side 334, which are defined with reference to a mirror surface 336. Run-off bores (not shown), in particular for oil, may be provided on the spectacles-type bearing bracket 330, these being arranged in a manner differing from the mirror symmetry. In the figure shown, the mirror surface 336 extends perpendicularly out of the plane of the drawing. A first barrel bearing 362 and a second barrel bearing 364 are arranged in mirrored positions (with the mirror axis at the mirror surface 336). A barrel bearing gap 368 is provided between the barrel bearings 362, 364, said gap forming an intermediate space 462. In the intermediate space 462, one end of each of the output shafts (see output shafts 37 and 39 in FIG. 3) can be placed into the barrel bearings 362, 364 at a distance from each other and thus without rubbing against each other. The intermediate space 462 can also be referred to as the lubrication space 462 for the barrel bearings 362, 364.

As the bearing lubrication chamber 450, the lubrication space 462 is at the same time part of a multi-chamber system 200^{I} which serves to return transmission oil to the sump (see sump 160 in FIG. 3) in a delayed manner. Transmission oil located in the bearing lubrication chamber 450 flows into the barrel bearings 362, 364 and, from the barrel bearings 362, 364, returns to the sump in a delayed manner after being circulated through the bearing circuit. Transmission oil is routed from two reservoir chambers 448, 448^{I}, via respectively connected nozzles with lubrication openings, such as the nozzle 440 with the opening 442, which serve as delay means 440, 442, into the bearing lubrication chamber 450. In each of the reservoir chambers 448, 448^{I}, a lubrication reservoir 446, 446^{I} is formed by a constant inflow from collection chambers 416, 416^{I}, arranged upstream in the flow direction. The two lubrication reservoirs 446, 446^{I} are regarded as a joint reservoir because the two barrel bearings 362, 364 are continuously supplied with transmission oil therefrom. Oil guides 412, 414 are provided on the spectacles-type bearing bracket 330. The oil guides 412, 414 are arranged as inclined surfaces, the lowermost end of which merges into a collection chamber 416, 416^{I}. The oil guides 412, 414 are shaped in the manner of a spatula or scraper. They are two blade-like structures with oil-guiding surfaces. Splash oil or oil droplets supplied to the collection chambers 416, 416^{I} via a predefined flow-off path (without a reference sign) accumulate on the oil guides 412, 414. The oil guides 412, 414 can also be regarded as part of the collection chambers 416, 416^{I}. The splash oil has been formed in particular by gears splashing in the sump or in a lubrication pan (see gear 77 and sump 160 or gear 75 and gear lubrication pan 208 in FIG. 3).

The barrel bearings 362, 364 are of identical construction, i.e. they each have barrel rolling elements, such as the barrel rolling element 372, which are guided in an outer barrel bearing ring, such as the barrel bearing ring 370. The outer barrel bearing ring 370 is held in the spectacles-type bearing bracket 330 by a retaining clip 366. The barrel bearings 362, 364 can thus be separated from the spectacles-type bearing bracket 330 for maintenance after long-term operation, for example if bearing wear has occurred. This facilitates maintenance work, such as replacement or exchange of the bearings 362, 364.

A respective contact surface 436 of the pin receptacles, such as the first pin receptacle 424 or the second pin receptacle 426, is located in an intermediate region between an internal diameter 434 and an external diameter 432. For both pin receptacles 424, 426, mention can also be made of a contact surface, more precisely the contact surface 436, at which the pin receptacles 424, 426 end. A pin receptacle can also be referred to as a receptacle for a pin. A pin receptacle extension 438 is assigned to the contact surfaces, such as the contact surface 436, as a gap. A pin receptacle extension 438 is larger than the barrel bearing gap 368, which is defined by the outer barrel bearing rings, such as by the barrel bearing ring 370. The pin receptacle extension 438 spaces apart a pair of contact surfaces and is preferably larger than the external diameter 432. Pin receptacles, such as the pin receptacles 424, 426, are suitable for receiving a pin having a pin diameter that is only slightly smaller than the internal diameter 434, so that the pin can be received with as little play as possible in the opening having the internal diameter 434. A size of the external diameter 432 secures the pin receptacles 424, 226 against breaking free. The external diameter is preferably at least twice the internal diameter 434. All the pin receptacles 424, 426 may be of equal size.

Webs, such as the web 400^{I}, form a splined connection between the contact surfaces, such as the contact surface 436, and the hole structure 344. The web 400^{I} is tapered toward the first pin receptacle 424. The webs, such as the web 400^{I}, stiffen the spectacles-type bearing bracket 330 in a manner that is efficient in terms of material and weight, in particular against torsion.

To continue the description of the multi-chamber system 200^{I} according to FIG. 6, a first oil guide 412 on the first side 332 of the spectacles-type bearing bracket and a second oil guide 414 on the second side 334 of the spectacles-type bearing bracket are located opposite the first pin receptacle 424 when moving from the first pin receptacle 424 in a diagonal direction toward an opposite side of the hole structure 344. The oil guides 412, 414 are designed in a plate-like manner and have a larger extension toward the sides 332, 334 of the spectacles-type bearing bracket 330 than the webs, such as the web 400^{I} for example. The oil guides 412, 414 serve to collect oil that has been splashed upward by rotating gears. The oil is supplied via the oil-guiding surfaces 412, 414, which can also be referred to as oil guides, to a lubrication reservoir 446, 446^{I}. The inflow takes place in a manner driven by gravity, unless a driving acceleration causes the effect to be different. From the lubrication reservoir 446, 446^{I}, oil is discharged in an axial direction 444, or with a direction component along the axial direction 444, from at least one lubrication nozzle, such as the lubrication nozzle 440, via the lubrication opening 442 thereof. Aided by a nozzle angle position relative to the axial direction 444, oil passes to both sides of the barrel bearings 362, 364, i.e. transversely to the axial direction 444. Rotating surfaces (for example at ends of the output shafts 37, 39 in FIG. 3), which bound the intermediate space, additionally encourage the distribution of oil onto the barrel bearings 362, 364. The lubrication opening 442 is selected to be so large, preferably in a manner tailored to a viscosity of the transmission oil, that a lubrication can take place as reliably and evenly as possible, for example as droplets or as a narrow flow.

FIG. 7 shows a perspective view of the spectacles-type bearing bracket 330, looking toward the first side 332 of the spectacles-type bearing bracket. The second side 334 of the spectacles-type bearing bracket is structured identically to the first side 332 of the spectacles-type bearing bracket. By looking at FIG. 3, it can easily be deduced that it can also be said that the first side 332 of the spectacles-type bearing bracket can be used to mount at least one component of a first sub-transmission 15 and the second side 334 of the spectacles-type bearing bracket can be used to mount at least one component of a second sub-transmission 17.

As can also be seen from FIG. 7, located on the web plate 352 of the spectacles-type bearing bracket 330 is a first oil guide 412, which is assigned to the first side 332 of the spectacles-type bearing bracket, and a second oil guide 414, which is assigned to the second side 334 of the spectacles-type bearing bracket. The oil guides 412, 414 can also be referred to as protruding reinforcements of the web plate 352. The oil guides 412, 414 together with the web plate 352 form a pocket-like oil collection region 416. The oil guides 412, 414 extend from the vicinity of a pin receptacle, namely the third pin receptacle 428, to the respective collection chamber, such as the collection chamber 416. The oil guides 412, 414 and the collection chambers 416, as well as the bearing lubrication chamber 450, belong to a multi-chamber system 200^{I}, which is advantageous for passive oil guidance in a transmission or transmission case (see for example transmission 1 or sub-transmission 17 and transmission case 31 in FIG. 3).

As a further interesting aspect, it can be mentioned with regard to a structural reinforcement of the web plate 352 that the plate-like oil guides 412, 414 projecting perpendicularly from the web plate 352 are a stabilizing structural element of the single-hole support structure 342 and thus of the spectacles-type bearing bracket. Other elements that form stabilizing structures are hole structure supports, such as the hole structure support 346^{I}, webs, such as the first web 400, the second web 402, the third web 404, the fourth web 406, as well as a first web intersection 408 and a second web intersection 410. Web intersections, such as the first web intersection 408 and the second web intersection 410, are formed in each case of two or three intersecting webs. Stabilizing structural elements serve to dissipate forces, such as deformation forces or lever forces, which act on the hole structure 344 in an operating state of a transmission, to the pin receptacles, such as the first pin receptacle 424, the second pin receptacle 426, the third pin receptacle 428 or the fourth pin receptacle 430, in a manner that is spatially distributed as evenly as possible. The aforementioned forces or structural loads that occur during operation are transmitted to the case (see sub-case 331 in FIG. 8) by dissipation via the spectacles-type bearing bracket 330 (and thus the load limit for plastic deformations is observed). Further stabilizing structural elements of the single-hole support structure 342 are edge webs arranged at the edge region 418, such as a first edge web 420 and a second edge web 422, as well as the regions of the web plate 352 arranged between or next to the webs 402, 404, 406, 408, 410.

The view shown in FIG. 8 illustrates one possible way of installing the spectacles-type bearing bracket 330 in a sub-case 331 for a first single transmission, such as for example the single transmission 15 in FIG. 3. A complete transmission 1^{II} can thus be assembled, which is suitable for a motor vehicle 500 or 500^{I} according to FIG. 1 or FIG. 2. A rolling bearing 369 for bearing an output shaft sleeve in a rotatable manner, such as the output shaft sleeve 337, but which is arranged at an end of the output shaft 39^{I} toward the sub-case 331 that is hidden in this perspective, is held in the sub-case 331 by a retaining clip 394. At an opposite end region of the output shaft 39^{I}, at which the output shaft sleeve 337 is provided, the output shaft 39^{I} (see also the output shafts 37, 39 shown in FIG. 3) is borne in the spectacles-type bearing bracket 330 via a floating bearing 380 together with an associated wheel bearing surface of the output shaft 39^{I}. The retaining clip 366^{I} to be installed on the spectacles-type bearing bracket 330 in order to axially secure the barrel bearing 364 has been illustrated in an exposed manner for better clarity.

It can also be said that the single-hole support structure 342 forms part of the floating bearing 380.

The pin receptacles, such as the first pin receptacle 424, of the spectacles-type bearing bracket 330 form a mounting frame 340 for the floating bearing 380. The mounting frame 340 can be attached to the pin holders, such as the pin holder 460, a first pin holder, by the pin receptacles, such as the pin receptacle 424. The third pin receptacle 428 is located diagonally opposite the first pin receptacle 424 on the spectacles-type bearing bracket 330 and is associated with a pin holder 460^{I} which, depending on the manner of counting, can also be referred to as the third pin holder. The pin holders 460, 460^{I} each have support surfaces 458, 458^{I}. The contact surface 436 (see FIG. 6) and the support surface 458 (see FIG. 8) are associated with each other. An axial position of the spectacles-type bearing bracket 330 along the half-axles 520, 522 is thus defined (see FIG. 3). To attach the spectacles-type bearing bracket 330, a first pin 382 can be passed through the first pin receptacle 424. In the installed state of the spectacles-type bearing bracket 330, the first pin 382 is firmly seated in the pin holder 460. Accordingly, the spectacles-type bearing bracket 330 is held by at least three pins 382, 384, 386. In the illustration shown in FIG. 8, a second pin 384 and a third pin 386 can be seen. A fourth pin, which is also present, is concealed. The pins 382, 384, 386 define a radial position of the spectacles-type bearing bracket 330 transversely to the half-axles 520, 522, such as the third position 23 (see FIG. 3). It can be said that the pins 382, 384, 386 form an assembly system or an assembly array for an outer bearing 374 of the half-axles 520, 522 (see FIG. 1 or FIG. 2), in particular created by the spectacles-type bearing bracket 330. The pins 382, 384, 386 have a greater length than the pin receptacle extension 438 in FIG. 6. In other words, the pins 382, 384, 386 with their respective first pin ends are held in a hole of a corresponding pin holder, such as the pin holders 460, 460^{I}, which form part of the (sub-)case 331. Once the spectacles-type bearing bracket 330 has been inserted in the first sub-case 331, this structural unit consisting of the spectacles-type bearing bracket 330 and the sub-case 331 is latched together, so to speak, and can be brought into an angle position, without slipping, for further assembly purposes. This facilitates assembly of the sub-transmission, such as the sub-transmission 15 in FIG. 3. The four pins (see pins 382, 384, 386) are additionally held with their second ends on a second sub-case (not shown), which serves to accommodate a second sub-transmission, such as the sub-transmission 17 in FIG. 3, to construct a dual transmission 1^{I}. Owing to its preferred design or the parallel arrangement of shafts, the dual transmission 1^{II} can also be referred to as a longitudinal transmission in relation to a vehicle longitudinal axis 524 (see FIG. 1 or FIG. 2).

The design possibilities shown in the individual figures can also be combined with each other in any form.

For instance, it is possible to make the partition walls 73, 73^{I} longer or shorter and yet still leave one complete, contiguous oil space in the transmission case 31.

Of course, it is also possible for the transmission 1, which according to FIG. 1 is arranged with its center of gravity in front of the rear axle 518, to be installed in a vehicle in such a way that it is located with its center of gravity behind the rear axle 518, as shown in FIG. 2 using the example of the transmission 1^{I}. The transmission 1^{II}, which is shown in FIG. 8 not with all the components because FIG. 8 deals in particular with the arrangement of the spectacles-type bearing bracket and of the output in the transmission, can be supplemented with other components, such as a dual input shaft 32 and components of the stationary middle axle 45, according to FIG. 3 or according to FIG. 4, to form a complete transmission, and can be closed by a second case shell.

The central axle 45, which is shown as hollow in FIG. 3, may be designed in a solid fashion. The axles 33, 35, 37, 39 may also be hollow.

A person skilled in the art understands that the rear-axle drive variant of a motor vehicle 500 of a vehicle with front-axle drive, which is shown by way of example in FIG. 1 or FIG. 2, can also be accordingly reconfigured for a front-axle drive variant. In this case, not only does the steering movement from the steering wheel 514 act, by way of the steering linkage 516, on the road wheels 510, 512 and the angle position thereof, but also the powertrain 3 opens into the road wheels 510, 512.

The invention can also be presented as follows. A transmission 1, for example for a duo electric machine powertrain, has a sump 160, into which at least a first gear 77 dips. Adjacent to a multi-chamber system 200, a gear stage 55 is formed by a first gear 77 and a second gear 49, 35 50, 79. The second gear 49, 50, 79 performs the function of a centrifugal lubricating film separator gear for separating oil from the surface of the gear 49, 50, 79, by using a centrifugal force, and delivering said oil to the multi-chamber system 200. The multi-chamber system 200 acts as a flow path which continuously delivers a lubricant 162 and by way of which lubricant can enter the sump 160 through a delay means 180, 180^{I}, 180^{II}. Such a system can also be part of a spectacles-type bearing bracket. In the case of such a multi-chamber system 200, lubricant 162 that is splashed by the second gear 49, 50, 79 is received in one chamber 202, 204 of the multi-chamber system 200, is stored in a further chamber 204, 206, and is recirculated to the sump 160 only via a delay means 180, 180^{I}, 180^{II}.

### LIST OF REFERENCE SIGNS

1, 1^{I}, 1^{II} dual transmission or twin transmission, designed as a spur gear transmission
3, 3^{I} powertrain, in particular duo electric machine powertrain
5, 5^{II} first electric machine
5^{I} first drive torque
7, 7^{II} second electric machine
7^{I} second drive torque
9 energy store, in particular electrical accumulator
11 first electrical lead
13 second electrical lead
15 single transmission, in particular first single transmission or sub-transmission
17 single transmission, in particular second single transmission or sub-transmission
19 position, first
21 position, second, middle
23 position, third
25 gear center, in particular first gear center
27 gear center, in particular second gear center
29 gear center, in particular third gear center
31 transmission case
32 dual input shaft
33 input shaft
35 input shaft
37 output shaft
39, 39^{I} output shaft
41 case wall
43 case wall
44 axle, in particular of the input shafts
45 axle, middle
49, 49^{I} third gear, in particular driven spur gear in traction mode
50, 50^{I} second gear, in particular output spur gear in traction mode
51 case bottom
53 stage, first, in particular gear stage with ratio
55 stage, second, in particular gear stage with ratio
57, 57^{I} tooth
59, 59^{I} tooth
61 needle bearing
63 needle bearing
65 rolling bearing
67 rolling bearing
69 rolling bearing
71 rolling bearing
73, 73^{I} case wall, in particular case partition wall, such as a spectacles-type bearing bracket
75, 75^{I} fourth gear, in particular of the input shaft
77, 77^{I} first gear, in particular spur gear of the output shaft
79 stepped gear
102 inner side, first inner side
104, 104^{I} inner side, second inner side
106 width
108 internal volume
110 center, in particular of the case, or central region of the case
114 gear axle, in particular stationary gear axle
116 sleeve
118, 118^{I}, 118^{II} bore
120 case longitudinal direction
130 breather cap or breather element
134 first portion, in particular thicker portion
136 second portion, in particular narrower portion
160 sump
162 lubricant
164 first lubricant level, in particular of the sump
166, 166^{I}, 166^{II} further lubricant level, in particular second lubricant level
168 third lubricant level, in particular of the sump
180, 180^{I}, 180^{II} delay means
182 nozzle
184 shutter
186 choke
188 flow valve
190 gravity run-off path
200 chamber system, in particular multi-chamber system
202 drip chamber, in particular uppermost chamber
204, 204^{I} collection chamber, in particular first reservoir-forming chamber
206 reservoir chamber, in particular lowermost chamber
208 gear lubrication pan, in particular gear lubrication chamber
210 wall support, in particular bearing support
212 aperture, in particular equalizing flow opening
220 surface lubrication
222, 222^{I} discharge-side part
224 flow-off barrier
226 oil-guiding wall, in particular in the form of an oil scraper
228 separating magnet
230 first splash tooth
232 second splash tooth
234 oil collection pan
240 first gear segment
242 second gear segment
244 third gear segment
250 running surface of a gear
260 direction of rotation of gear
330 spectacles-type bearing bracket
331 sub-case of the transmission
332 first side of the spectacles-type bearing bracket
334 second side of the spectacles-type bearing bracket
336 mirror surface
337 output shaft sleeve
338 output direction
340 mounting frame
342 single-hole support structure
344 hole structure
346, 346^{I} hole structure support
348 support collar
352 web plate
354 first narrow side of plate 356 second narrow side of plate
358 first long side of plate
360 second long side of plate
362 first barrel bearing, in particular rolling-element bearing
364 second barrel bearing, in particular rolling-element bearing
366, 366^{I} retaining clip
368 barrel bearing gap, in particular gap between two rolling-element bearings
369 rolling bearing
370 outer barrel bearing ring, in particular running surface
372 barrel rolling elements
374 outer bearing
380 floating bearing, in particular wheel bearing surface
382 first pin
384 second pin
386 third pin
394 retaining clip
396 gear, in particular third gear
400, 400^{I} first web
402 second web
404 third web
406 fourth web
408 first web intersection
410 second web intersection
412 first oil guide, in particular oil supply surface
414 second oil guide, in particular oil supply surface
416, 416^{I} oil collection region, in particular collection chamber for oil droplets
418 edge of spectacles-type bearing bracket
420 first edge web
422 second edge web
424 first pin receptacle
426 second pin receptacle
428 third pin receptacle
430 fourth pin receptacle
432 external diameter of the pin receptacle
434 internal diameter of the pin receptacle
436 contact surface
438 pin receptacle extension
440 delay means, in particular lubrication nozzle
442 delay means, in particular lubrication opening such as a shutter opening
444 axial direction of the nozzle
446, 446^{I} lubrication reservoir
448, 448^{I} reservoir chamber
450 bearing lubrication chamber
458, 458^{I} support surface
460, 460^{I} pin holder, in particular first pin holder
462 intermediate space
500, 500^{I} motor vehicle
502 direction of travel
504 vehicle floor
506 first road wheel
508 second road wheel
510 third road wheel
512 fourth road wheel
514 steering wheel
516 steering linkage
518, 518^{I} vehicle rear axle
520 first half-axle
522 second half-axle
524 vehicle longitudinal axis
526 rear compartment
528 trunk region
532 coupling
534 coupling
A section plane
B reference plane
G straight line
M region, in particular middle region
d₁ diameter of a gear 49, 49^{I}
d₂ diameter of a gear 50, 50^{I}
β₁ angle of inclination
β₂ angle of inclination

1.-16. (canceled)

17. A twin transmission of a dual electric machine powertrain, the twin transmission comprising:
a gear stage including a first gear and a second gear, the second gear being a centrifugal lubricating film separator gear, the second gear being at a highest gear location of the twin transmission in a mounting orientation of the twin transmission corresponding to a mounted position of the twin transmission in the powertrain;
a sump, into which at least the first gear is configured to dip with at least one gear segment;
a multi-chamber system adjacent to the gear stage; and
a delay arrangement comprising at least one hydraulic flow restrictor, the multi-chamber system being configured to provide a flow path that continuously delivers a lubricant into the sump through the at least one hydraulic flow restrictor of the delay arrangement.

18. The twin transmission according to claim 17, wherein the twin transmission is a passively lubricated transmission.

19. The twin transmission according to claim 17, wherein the at least one hydraulic flow restrictor is selected from the group consisting of a nozzle, a shutter, a choke, and a flow valve.

20. The twin transmission according to claim 17, comprising two sub-transmissions, each sub-transmission being a two-stage or three-stage spur gear transmission comprising at least said first gear and said second gear, wherein at least one of said first gear and said second gear are stepped gears arranged in a contiguous internal volume within a transmission case.

21. The twin transmission according to claim 17, wherein the multi-chamber system comprises at least three chambers.

22. The twin transmission according to claim 17, wherein the multi-chamber system comprises plural chambers, from which lubricant located therein is able to run off under gravity, said plural chambers including an uppermost chamber from which the lubricant has a longest run-off distance under gravity, said uppermost chamber being a drip and collection chamber.

23. The twin transmission according to claim 17, wherein the multi-chamber system comprises a middle chamber, said middle chamber being a first reservoir chamber configured to hold lubricant ready for delayed discharge.

24. The twin transmission according to claim 23, wherein the delay arrangement is placed on a discharge side of the first reservoir chamber.

25. The twin transmission according to claim 17, wherein the twin transmission is configured with two three-stage transmission paths arranged in parallel, each transmission path comprising said gear stage, said sump, said multi-chamber system and said delay arrangement, wherein
each transmission path is configured for a separate powertrain of the dual electric machine powertrain, and
each transmission path comprises a connection, for drive purposes, to one separate electric machine of the dual electric machine powertrain.

26. The twin transmission according to claim 17, wherein the sump adjoins a lowermost chamber of the multi-chamber system, or alternatively the lowermost chamber merges into the sump.

27. The twin transmission according to claim 17, further comprising:
at least one splash tooth; and
a gear lubrication pan at a distance from the sump, the gear lubrication pan comprising a flow-off barrier to prevent lubricant from flowing off into the sump,
the flow-off barrier being configured to allow a lubricant level in which the at least one splash tooth fits for splashing.

28. The twin transmission according to claim 17, further comprising output shafts having third gears and bearings, the output shafts being supported at their ends by a single spectacles-type bearing bracket configured as a single-hole support structure.

29. The twin transmission according to claim 28,
wherein the spectacles-type bearing bracket is a plate tapering toward its edges, the plate being shaped around a central opening.

30. A dual electric machine powertrain comprising the twin transmission of claim 17.

31. The twin transmission according to claim 17, wherein the second gear is configured to rotate at a medium speed.

32. The twin transmission according to claim 17, wherein the twin transmission is a pump-free transmission, configured for:
lubricant distribution taking place counter to gravity, wherein lubricant is provided over running surfaces of the first gear and the second gear by rotations of the first gear and the second gear; and
gravity-aided delayed lubricant dispensing.

33. The twin transmission according to claim 17, further comprising
a transmission case having a first reservoir chamber or having a first reservoir chamber and a second reservoir chamber of the multi chamber system inside the transmission case, at least one of said reservoir chambers having a wall with a discharge side, the wall comprising a hydraulic flow restrictor of the delay arrangement being placed at a location of the wall at a lowest point in the wall while the transmission case is in the mounting orientation.

34. The twin transmission according to claim 17, having an open flow path configured for continuous lubricant reflux after a first start-up phase, wherein the multi-chamber system is configured to passively remain in an open state after an end of operation of the twin transmission, thus providing said open flow path.

35. The twin transmission according to claim 29,
further comprising stabilizing webs protruding from said plate into spaces for two drive gears,
said plate comprising at least one lubrication nozzle opening radially into a bearing lubrication chamber between the bearings,
the lubrication nozzle configured for being supplied with oil from a lubrication reservoir of a reservoir chamber, the lubrication reservoir being designed for collecting splash oil via oil guiding surfaces of the spectacles-type bearing bracket.

36. A spur gear transmission of a dual electric machine powertrain, comprising gears inclusive of a first gear with splash teeth, a multi-chamber system, a transmission case, a sump and a delay arrangement, wherein
the transmission case is configured for a passive lubricating film distribution, wherein lubricant stays distributed over all the running surfaces of the spur gear transmission by rotation of the gears,
at least one surface inside the transmission case is arranged with an angle or a slope for guiding the lubricant towards or inside the multi-chamber system,
one chamber of the multi chamber system is a receiving chamber for the lubricant after being splashed as a result of a centrifugal force inside the transmission case, the one chamber being configured for retaining the lubricant inside the transmission case in order to be stored in a further chamber of the multi-chamber system,
the delay arrangement is arranged in a lubricant flow path of the multi-chamber system, the lubricant flow path providing a path for the lubricant recirculating back into the sump in a delayed manner, and
the first gear with splash teeth is configured to convey the lubricant upwards from the sump by rotation of the first gear for surface lubrication.
